(19) United States
(12) Patent Application Publication
(10) Pub. No.: US 2018/0182384 A1
(43) Pub. Date: Jun. 28, 2018

(54) Stateful Context-Based Content Production Control

(71) Applicant: Elemental Path, Inc., New York, NY (US)

(72) Inventors: Donald Coolidge, New York, NY (US); John Paul Benini, New York, NY (US); Sean O'Shea, New York, NY (US); Arthur Tu, New York, NY (US); Jessica Cohen, New York, NY (US); Mark Garcia, New York, NY (US); Tinashe Musonza, Brooklyn, NY (US); Shane Tierney, Queens, NY (US); Calvin Chu, New York, NY (US)

(73) Assignee: Elemental Path, Inc., New York, NY (US)

(21) Appl. No.: 15/852,134

(22) Filed: Dec. 22, 2017

Related U.S. Application Data
(60) Provisional application No. 62/438,346, filed on Dec. 22, 2016.

(51) Int. Cl. G10L 15/18; G06N 5/02; G06N 99/00; G10L 15/22

(52) U.S. Cl. CPC G10L 15/1815; G06N 5/025; G10L 2015/223; G10L 15/22; G06N 99/005

(57) ABSTRACT

Techniques for controlling stateful context-based production of content. A system utilizing such techniques can include a stateful context-based user interaction management system and a stateful context-based interaction engagement device. A method utilizing such techniques can include selecting content to produce at a stateful context-based interaction engagement device according to contexts associated with user interactions with the stateful context-based interaction engagement device and causing the stateful context-based interaction engagement device to produce the selected content in response to the user interactions.

### RELATED APPLICATIONS

This application claims the priority of U.S. Provisional Application Ser. No. 62/438,346 filed Dec. 22, 2016, the entire disclosure of which is expressly incorporated herein by reference.

### BACKGROUND

The field of artificial intelligence is growing at a breathtaking rate. Indeed, in today's world, there is a marked increase in consumer devices which have embedded intelligence and which allow for interaction with various users using voice recognition, voice synthesis, natural language processing, and other computer-based technologies. While such technologies provide a rich user experience, there is still ongoing work in the AI field to develop even better user interaction technologies. In particular, there is a need to provide systems which adequately take into account the context of spoken human communications, so that AI systems can better interact with humans. Accordingly, the systems and methods of the present disclosure address these and other important needs.

### SUMMARY OF THE INVENTION

The present disclosure relates generally to the field of artificial intelligence. More specifically, the present disclosure relates to stateful, context-based content production control systems and methods that can be used with various devices such as consumer products, toys, etc. The systems and methods disclosed herein can take into account not only the context of human communications in order to provide a richer experience for the user, by they can also take into account both past and current human interactions. The systems and methods disclosed herein have particular applicability to electronic learning toys/aids for children.

### BRIEF DESCRIPTION OF THE DRAWINGS

FIG. 1 depicts a diagram 100 of an example of a system for controlling stateful context-based presentation of content according to user interaction with a physical device.

FIG. 2 depicts a flowchart 200 of an example of a method for producing content at a stateful context-based interaction engagement device based on a context associated with user interactions and a state of communications between the device and a user.

FIG. 3 depicts a flowchart 300 of an example of a method for operating a stateful context-based interaction engagement device.

FIG. 4 depicts a diagram 400 of an interaction input management system 402.

FIG. 5 depicts a flowchart 500 of an example of a method for transmitting interaction input for use in determining content to produce at a stateful context-based interaction engagement device.

FIG. 6 depicts a diagram 600 of an example of a content management system 602.

FIG. 7 depicts a flowchart 700 of an example of a method for maintaining data used in controlling production of content at a stateful context-based interaction engagement device.

FIG. 8 depicts a diagram 800 of an example of a state and context-based content production management system 802.

FIG. 9 depicts a flowchart 900 of an example of a method for producing content at a stateful context-based interaction engagement device based on user interactions with the device.

FIG. 10 depicts a diagram 1000 of an example of a skill metric management system 1002.

FIG. 11 shows a top perspective view of an example of a stateful context-based interaction engagement device.

FIG. 12 shows a side view of an example of a stateful context-based interaction engagement device.

FIG. 13 shows perspective view of a cross section of an example of a stateful context-based interaction engagement device.

FIG. 14 shows a side view of a cross section of an example of a stateful context-based interaction engagement device.

FIG. 15 depicts an electrical schematic of a printed circuit board included as part of an example stateful context-based interaction engagement device.

FIG. 16 depicts a diagram of an example of a system for controlling production of content at a stateful context-based interaction engagement device based on user interaction with the device.

FIG. 17 depicts a diagram of an example of a stateful context-based user interaction management system.

FIG. 18 is a screenshot of an example of a content management interface.

FIG. 19 is a screenshot of another example of a content management interface.

FIG. 20 is a screenshot of yet another example of a content management interface.

FIG. 21 is a screenshot of another example of a content management interface.

FIG. 22 is a screenshot of yet another example of a content management interface.

FIG. 23 is a screenshot of another view of the dashboard as described in FIG. 18.

FIG. 24 is a screenshot of a content management interface that makes recommendations for content adjustment.

FIG. 25 is another screenshot of the content management interface that allows a guardian to select academic subjects, from a tree-structured menu in content organization.

FIG. 26 is another screenshot of the content management interface that shows the device user's (the child's) activity, with frames for a particular content area (e.g. Mathematics).

FIG. 27 is a screenshot of a usage-wide roadmap that shows what the child has learned and where the child should be heading next in the topics.

FIG. 28 is a content management interface with content organized according to subject matter.

FIG. 29 is a content management interface with content organized according to conversation type.

FIG. 30 is a screenshot of a parent panel interface.

FIG. 31 is another screenshot of a parent panel interface.

FIG. 32 is a front view of a removable stateful context-based interaction engagement device.

FIG. 33 is a perspective view of a removable stateful context-based interaction engagement device integrated with a shell.

### DETAILED DESCRIPTION

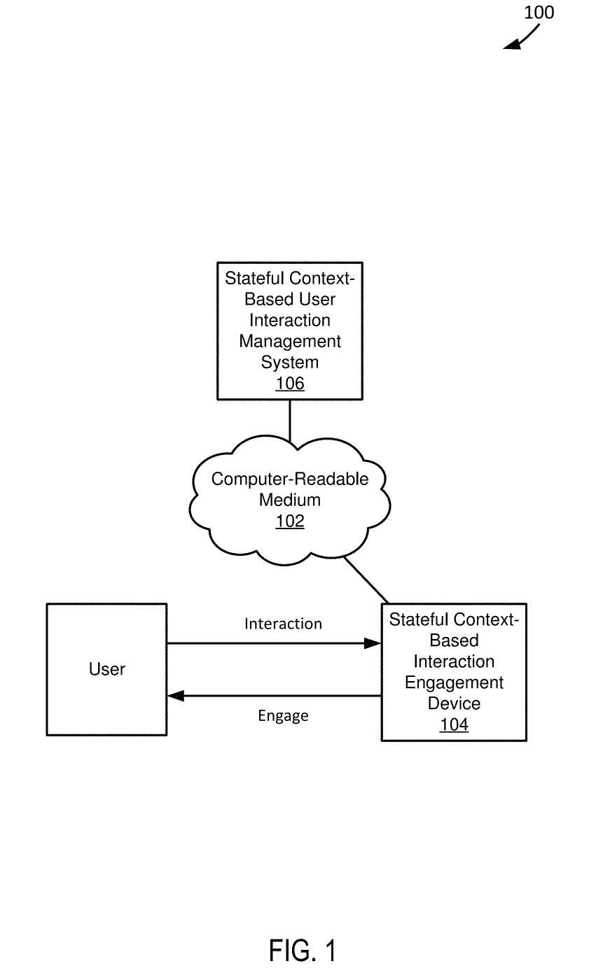

FIG. 1 depicts a diagram 100 of an example of a system for controlling stateful context-based presentation of content according to user interaction with a physical device. The system of the example of FIG. 1 includes a computer-readable medium 102, a stateful context-based interaction engagement device 104, and a stateful context-based user interaction management system 106.

The computer-readable medium 102 and other computer readable mediums discussed in this paper are intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 and other computer readable mediums discussed in this paper are intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The devices, systems, and computer-readable mediums described in this paper can be implemented as a computer system or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

Returning to the example of FIG. 1, the stateful context-based interaction engagement device 104 is intended to represent a physical device capable of communicating with a user. In communicating with a user, the stateful context-based interaction engagement device 104 can produce content in a perceivable manner to a user. Content can include human sensory detectable content capable of being produced to a user in a perceivable manner by the user. For example, content can include sounds produced for a user. A perceivable manner includes a manner in which a human is capable of perceiving produced content. For example, a perceivable manner can include playing audio content at a frequency a human is capable of hearing. Further, in engaging a user through by producing audio content for the user, the stateful context-based interaction engagement device 104 can be used to improve cognitive skills of a user by producing audio educational content. The stateful context-based interaction engagement device 104 can include applicable mechanisms for producing content in a perceivable manner as part of engaging a user. For example, the stateful context-based interaction engagement device 104 can include one or a combination of electromechanical devices capable of producing sound and display devices. A display device included as part of the stateful context-based interaction engagement device 104 can be used to communicate an applicable message such as ‘listening’, ‘talking’, ‘thinking’, ‘onboarding’, ‘error’ to a user.

The stateful context-based interaction engagement device 104 includes applicable mechanisms for capturing interaction input representing interactions a user has with the stateful context-based interaction engagement device 104. Interaction input can include data indicating auditory sounds a user makes in interacting with the stateful context-based interaction engagement device 104, movements a user makes in interacting with the stateful context-based interaction engagement device 104, and ways in which a user physically manipulates the stateful context-based interaction engagement device 104. For example, interaction input can include a recording of a question a user asks the stateful context-based interaction engagement device 104. In another example, interaction input can include data indicating a user activated an actuator of the stateful context-based interaction engagement device 104. Examples of applicable mechanisms for measuring capturing interactions a user has with the stateful context-based interaction engagement device 104 include microphones, cameras, video recorders, and actuators integrated as part of the stateful context-based interaction engagement device 104 itself.

In a specific implementation, a user of the stateful context-based interaction engagement device 104 is a child and the stateful context-based interaction engagement device 104 communicates with the child by producing content. In communicating with a user who is a child, the stateful context-based interaction engagement device 104 can facilitate learning or development of skills for the user. For example, the stateful context-based interaction engagement device 104 can be used to teach a child how to read. In another example, the stateful context-based interaction engagement device 104 can used to teach a child how to speak.

In a specific implementation, the stateful context-based interaction engagement device 104 functions to communicate with a user based on user interactions with the stateful context-based interaction engagement device 104. For example, if a user asks a question to the stateful context-based interaction engagement device 104, then the stateful context-based interaction engagement device 104 can play audio content including an answer to the question. In another example, if a user touches a specific part of the stateful context-based interaction engagement device 104, then the stateful context-based interaction engagement device 104 can play audio content associated with a user interacting with the specific part of the stateful context-based interaction engagement device 104.

The stateful context-based interaction engagement device 104 is context-based in that it can communicate with a user based on contexts associated with user interactions with the stateful context-based interaction engagement device 104. Contexts associated with user interactions with the stateful context-based interaction engagement device 104, include applicable contexts relevant to communicating with a user based on interactions the user has with stateful context-based interaction engagement device 104. Examples of contexts associated with user interactions with the stateful context-based interaction engagement device 104 include an identification of a user interacting with the stateful context-based interaction engagement device 104, characteristics of an instance of a user interacting with the stateful context-based interaction engagement device 104, how a user interacted in an instance with the stateful context-based interaction engagement device 104, characteristics of the stateful context-based interaction engagement device 104 in being interacted with by a user, characteristics of the stateful context-based interaction engagement device 104 in communicating with a user, and characteristics of communications with a user by the stateful context-based interaction engagement device 104. For example, contexts associated with user interactions with the stateful context-based interaction engagement device 104 can include an identification of specific content produced to a user in response to the user interacting with the stateful context-based interaction engagement device 104. In another example, contexts associated with user interactions with the stateful context-based interaction engagement device 104 can include a specific question a user asked the stateful context-based interaction engagement device 104 and a response to the question given by the stateful context-based interaction engagement device 104 in communicating with the user.

The stateful context-based interaction engagement device 104 is stateful in that it can communicate with a user based on past and current contexts associated with user interactions with the stateful context-based interaction engagement device 104, otherwise referred to as a maintained a state of communications. In communicating with a user based on past and current contexts associated with interactions of a user with the stateful context-based interaction engagement device 104, the stateful context-based interaction engagement device 104 can communicate with a user based on a maintained conversation a user has with the device as part of past and current contexts. For example, if the user continues to ask questions related to dinosaurs, then the stateful context-based interaction engagement device 104 can produce audio describing a history of dinosaurs. Further, in communicating with a user based on past and current contexts associated with user interactions with the stateful context-based interaction engagement device 104, the stateful context-based interaction engagement device 104 can communicate with the user based on communications that occurred at past locations of the device. For example, if the stateful context-based interaction engagement device 104 produces audio describing animals when the device is at a natural history museum, and the stateful context-based interaction engagement device 104 is currently at the natural history museum, then the stateful context-based interaction engagement device 104 can produce more audio describing animals.

The stateful context-based interaction engagement device 104 can be shaped in a zoomorphic or anthropomorphic form. For example, the stateful context-based interaction engagement device 104 can be shaped like a dinosaur. In being shaped in a zoomorphic or anthropomorphic form, the stateful context-based interaction engagement device 104 can include a housing that is shaped in a zoomorphic or anthropomorphic form. Further, in being shaped in a zoomorphic or anthropomorphic form, the stateful context-based interaction engagement device 104 can promote engagement with a child to cause the child to interact with the stateful context-based interaction engagement device 104. For example, the stateful context-based interaction engagement device 104 can be shaped as a dinosaur to cause a child to feel comfortable with asking the stateful context-based interaction engagement device 104 questions.

In a specific implementation, the stateful context-based interaction engagement device 104 includes a wired or wireless network interface used by the stateful context-based interaction engagement device 104 to access network services of a network. For example, the stateful context-based interaction engagement device 104 can include a WiFi interface that is used to communicate wirelessly through a wireless network. A network interface of the stateful context-based interaction engagement device 104 can be used to transmit interaction input from the stateful context-based interaction engagement device 104. For example, a network interface can be used to transmit from the stateful context-based interaction engagement device 104 a stream of a user speaking to the stateful context-based interaction engagement device 104. Further a network interface of the stateful context-based interaction engagement device 104 can be used to receive at the stateful context-based interaction engagement device 104 content to produce for a user. For example, a network interface can be used to receive audio files to produce to a user by the stateful context-based interaction engagement device 104.

In a specific implementation, a network interface of the stateful context-based interaction engagement device 104 functions to be used to receive data for controlling production of content by the stateful context-based interaction engagement device 104. For example, a network interface can be used to receive a content production command indicating to display specific content and the stateful context-based interaction engagement device 104 can subsequently display the specific content based on receipt of the content production command. In another example, the stateful context-based interaction engagement device 104 can receive stateful context-based content production rules and subsequently produce content according to the stateful context-based presentation rules. For example, if stateful context-based content production rules specify to produce a specific audio of an answer to a question in response to a user asking the question, then the stateful context-based interaction engagement device 104 can produce the specific audio of the answer.

In a specific implementation, the receipt of specific content, at the stateful context-based interaction engagement device 104 functions to serve as a content production command indicating to display the specific content. For example, the stateful context-based interaction engagement device 104 can display an audio message automatically once it receives the audio message. Content production commands can be received at a network interface of the stateful context-based interaction engagement device 104 based on either or both state and context. For example, if a user asks a question to the stateful context-based interaction engagement device 104 then the stateful context-based interaction engagement device 104 can receive audio of an answer to the question, thereby serving as a content production command, and subsequently play the audio of the answer to the question.

In a specific implementation, the stateful context-based interaction engagement device 104 functions to serve as a session initiation protocol (hereinafter referred to as “SIP”) client. In functioning as a SIP client, the stateful context-based interaction engagement device 104 can transmit audio streams as part of an SIP voice-only call, and receive content to produce as in response to the SIP voice-only call. For example, the stateful context-based interaction engagement device 104 can transmit an audio stream of questions a user asks through an SIP voice-only call and receive audio content including answers to the questions, which the stateful context-based interaction engagement device 104 can subsequently produce the audio content for the user. The stateful context-based interaction engagement device 104 can initiate an SIP voice-only call by activating an actuator included as part of the stateful context-based interaction engagement device 104. Additionally, the stateful context-based interaction engagement device 104 can establish an SIP voice-only call according to an applicable protocol, e.g. RFC 4964.

Referring back to FIG. 1, the stateful context-based user interaction management system 106 is intended to represent a system that functions to manage production of content based on user interactions with an applicable device for producing content, such as the stateful context-based interaction engagement devices described in this paper. For example, the stateful context-based user interaction management system 106 can cause production of an audio recording of an answer to a question in response to a user asking the question. The stateful context-based user interaction management system 106 can be implemented at either or both an applicable device for production of content based on user interactions, such as the stateful context-based interaction engagement devices described in this paper, and remote from such devices. For example, a portion of the stateful context-based user interaction management system 106 for causing production of content can be implemented at a stateful context-based interaction engagement device, while a portion of the stateful context-based user interaction management system 106 for maintaining content to be produced can be implemented remote form the stateful context-based interaction engagement device. Portions of the stateful context-based user interaction management system 106 can be implemented at an SIP express media server (hereinafter referred to as “SEMS”) and communicate using an applicable protocol compatible with SEMS.

In a specific implementation, the stateful context-based user interaction management system 106 can determine specific content to produce and subsequently cause production of the content. In determining specific content to produce and subsequently causing production of the content, the stateful context-based user interaction management system 106 can either or both generate a content production command indicating to produce specific content and provide the specific content to an applicable device for reproducing the content. For example, if the stateful context-based user interaction management system 106 determines to produce specific content, then it can provide the specific content to a content production device, which can subsequently produce the specific content in response to receiving the content. In another example, specific content can reside at a content production device, and if the stateful context-based user interaction management system 106 determines to produce the specific content, then it can provide a content production command indicating to produce the specific content to the device, which can subsequently produce the content based on receipt of the command.

In a specific implementation, the stateful context-based user interaction management system 106 can determine specific content to produce according to stateful context-based content production rules. Stateful context-based content production rules include applicable rules directing whether to produce content based on contexts associated with user interactions with a stateful context-based interaction engagement device and a state related to communications with the user. Stateful context-based content production rules can map specific contexts associated with user interactions with a stateful context-based interaction engagement device to specific content to produce in response to a determination of an occurrence of the specific contexts. In mapping specific contexts associated with user interactions with a stateful context-based interaction engagement device to specific content, stateful context-based content production rules can map semantic constructs, as indicated by a determined context of user interactions, to content to produce. For example, stateful context-based content production rules can map the semantic construct of the phrase “what color is the ocean?” to an audio representation of the answer “blue.” Additionally, stateful context-based content production rules can map specific states of communications to specific content to produce in response to achievement of the specific states. For example, if a user is able to solve specific math problems, as indicated by a state of communications with the user, then stateful context-based content production rules can specify producing content related to a more challenging level of math problems.

In a specific implementation, the stateful context-based user interaction management system 106 functions to determine contexts associated with user interactions with a stateful context-based interaction engagement device for use in determining content to produce. For example, if a specific user is interacting with a stateful context-based interaction engagement device, then the stateful context-based user interaction management system 106 can determine the context that the specific user is the user interacting with the stateful context-based interaction engagement device. In determining contexts associated with user interactions with a stateful context-based interaction engagement device, the stateful context-based user interaction management system 106 can associate semantic constructs to interactions a user has with a stateful context-based interaction engagement device. For example, if a user asks the question “why is the sky blue?,” then the stateful context-based user interaction management system 106 can associate the semantic construct of the phrase “why is the sky blue?” with the instance of the user in asking the question. The stateful context-based user interaction management system 106 can use generated interaction input to determine contexts associated with user interactions with a stateful context-based interaction engagement device. For example, the stateful context-based user interaction management system 106 can associate a semantic construct to a recording, interaction input, of words spoken by a user in interacting with the stateful context-based interaction engagement device 104.

In a specific implementation, the stateful context-based user interaction management system 106 functions to select stateful context-based content production rules to apply for determining whether to produce specific content. The stateful context-based user interaction management system 106 can select stateful context-based content production rules based on determined contexts associated with user interactions with a stateful context-based interaction engagement device. For example, if a six year old child is interacting with a stateful context-based interaction engagement device, then the stateful context-based user interaction management system 106 can select stateful context-based content production rules associated with six year old children. Additionally, the stateful context-based user interaction management system 106 can select stateful context-based content production rules to apply based on a maintained state of communications. For example, if a user in interacting with a stateful context-based interaction engagement device has met all milestones within a specific skill level, then the stateful context-based user interaction management system 106 can select stateful context-based content presentation rules for controlling production of content in a next skill level.

In a specific implementation, the stateful context-based user interaction management system 106 functions to determine a semantic construct of words spoken by a user in interacting with a stateful context-based interaction engagement device, as part of determining contexts associated with user interactions with a stateful context-based interaction engagement device. The stateful context-based user interaction management system 106 can use a rule-based mechanism to determine a semantic construct of words spoken by a user. Additionally, the stateful context-based user interaction management system 106 can use natural language processing or structured machine language processing to determine a semantic construct of words spoken by a user in interacting with a stateful context-based interaction engagement device. For example, the stateful context-based user interaction management system 106 can apply machine learning to previous utterances made by a user to develop a natural language processing mechanism specific to the user, for utilization in determining semantic constructs of utterances made by the user. Further, the stateful context-based user interaction management system 106 can first apply a rule-based mechanism and then natural language processing to determine a semantic construct of words spoken by a user in interacting with a stateful context-based interaction engagement device.

In a specific implementation, the stateful context-based user interaction management system 106 functions to maintain a state of communications between a user and a stateful context-based interaction engagement device. The stateful context-based user interaction management system 106 can maintain a state of communications between a user and a stateful context-based interaction engagement device based on determined contexts associated with user interactions with a stateful context-based interaction engagement device. For example, if the stateful context-based user interaction management system 106 determines a user uttered a specific phrase, then the stateful context-based user interaction management system 106 can update a state of communications to indicate the user uttered the specific phrase in interacting with a stateful context-based interaction engagement device. In another example, if the stateful context-based user interaction management system 106 determines a stateful context-based interaction engagement device produced specific content for a user, then the stateful context-based user interaction management system 106 can update a state of conversion to indicate that the specific content was produced for the user.

In a specific implementation, in maintaining a state of communications, the stateful context-based user interaction management system 106 can maintain a dialog tree. A dialog tree represents a state of communications between a user and a stateful context-based interaction engagement device. A dialog tree can include interaction input indicating how a user interacted with a stateful context-based interaction engagement device, contexts associated with user interactions with a stateful context-based interaction engagement device, e.g. a semantic construct of utterances made by a user, times at which specific interactions by a user occurred, content produced in response to interactions, and times at which content was produced in response to interactions. For example, a dialog tree can indicate a conversation between a user and a stateful context-based interaction engagement device. A dialog tree maintained by the stateful context-based user interaction management system 106 can be used in determining content to produce for a user based on user interactions with a stateful context-based interaction engagement device. For example, if a dialog tree indicates a user has continued to answer a question wrong, and a user correctly answers the question, as indicated by a context, then it can be determined to produce content congratulating the user.

In a specific implementation, the stateful context-based user interaction management system 106 functions to maintain a user profile for a user. A user profile maintained by the stateful context-based user interaction management system 106 can include application information related to communications by a stateful context-based interaction engagement device. For example, a user profile can include states of communications between a stateful context-based interaction engagement device and a user, content produced for a user, interactions a user has with a stateful context-based interaction engagement device, skills and proficiencies of a user, characteristics of a user, mechanisms developed for a user to determine contexts of the user's interactions. For example, a user profile can indicate a user is six years old and has a second grade reading level. A user profile can be used to determine contexts associated with user interactions with a stateful context-based interaction engagement device. For example, if a user profile indicates a child is registered at a specific school, then the user profile can be used to determine a stateful context-based interaction engagement device is located at the specific school. Additionally, a user profile can be used to determine content to produce for a user by the stateful context-based interaction engagement device.

In a specific implementation, the stateful context-based user interaction management system 106 provides functionalities to a user for controlling production of content by a stateful context-based interaction engagement device. In providing functionalities to a user for controlling production of content, the stateful context-based user interaction management system 106 can receive content to produce from a user. For example, a teacher can provide content as part of a lesson plan to produce at a stateful context-based interaction engagement device. Further, in providing functionalities to a user for controlling production of content, the stateful context-based user interaction management system 106 can allow a user to create and modify stateful context-based content production rules. For example, a parent can set a trigger to produce content at a reading level if their child's reading skills have progressed to the reading level.

In a specific implementation, the stateful context-based user interaction management system 106 functions to maintain metrics related to communications of a user and a stateful context-based interaction engagement device. Metrics related to communications of a user and a stateful context-based interaction engagement device include applicable metrics describing communications by a stateful context-based interaction engagement device based on user interactions with the device. For example, metrics related to communications can include interactions a user has with a stateful context-based interaction engagement device, content produced for a user based on interactions, and skill levels achieved by a user. In maintaining metrics related to communications of a user and a stateful context-based interaction engagement device, the stateful context-based user interaction management system 106 can determine a skill level of a user. For example, if a person at a second grade math level is able to answer specific questions correctly, and a user correctly answers the specific questions, then the stateful context-based user interaction management system 106 can determine the user is at a second grade math level. The stateful context-based user interaction management system 106 can use contexts associated with user interactions with a stateful context-based interaction engagement device to determine skill levels of users.

In a specific implementation, the stateful context-based user interaction management system 106 provides functionalities to a user for viewing metrics related to communications with a user and a stateful context-based interaction engagement device. For example, the stateful context-based user interaction management system 106 can provide a portal through which a parent can view skill levels of their child. In another example, the stateful context-based user interaction management system 106 can provide a portal through which a parent can view what content is being produced at a stateful context-based interaction engagement device for their child.

In an example of operation of the example system shown in FIG. 1, the user interacts with the stateful context-based interaction engagement device 104. In the example of operation of the example system shown in FIG. 1, the stateful context-based interaction engagement device 104 generates interaction input based on the interaction of the user with the stateful context-based interaction engagement device 104. Further, in the example of operation of the example system shown in FIG. 1, the stateful context-based user interaction management system 106 determines a context associated with the user interactions with the stateful context-based interaction engagement device 104. In the example of operation of the example system shown in FIG. 1, the stateful context-based user interaction management system 106 determines content to produce based on the determined context and a maintained state of communications between the stateful context-based interaction engagement device 104 and the user. Additionally, in the example of operation of the example system shown in FIG. 1, the stateful context-based user interaction management system 106 causes the stateful context-based interaction engagement device 104 to produce the context based on the interactions of the user.

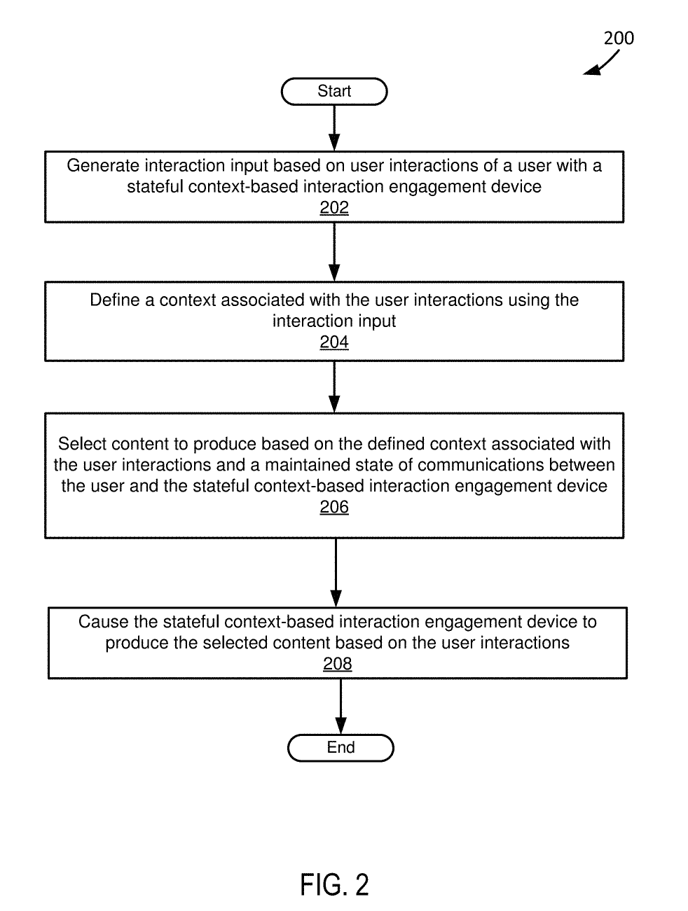

FIG. 2 depicts a flowchart 200 of an example of a method for producing content at a stateful context-based interaction engagement device based on a context associated with user interactions and a state of communications between the device and a user. The flowchart 200 begins at module 202, where interaction input is generated based on user interactions of a user with a stateful context-based interaction engagement device. An applicable system for managing production of content based on contexts associated with user interactions and states of communications, such as the stateful context-based user interaction management systems described in this paper, can generate interaction input based on user interactions of a user with a stateful context-based interaction engagement device. Interaction input can be generated by an applicable device for capturing user interactions with a stateful context-based interaction engagement device, such as a microphone or a video recorder. For example interaction input of a recording of utterances made by a user can be generated by a microphone.

The flowchart 200 continues to module 204, where a context associated with the user interactions is defined using the interaction input. An applicable system for managing production of content based on contexts associated with user interactions and states of communications, such as the stateful context-based user interaction management systems described in this paper, can define a content associated with the user interactions using the interaction input. In defining a context associated with the user interactions, one or a combination of characteristics of the user, characteristics of the stateful context-based interaction engagement device, and characteristics of the user interactions can be defined. For example, a semantic construct for the user interactions can be defined. In another example, an identification of the user can be identified.

The flowchart 200 continues to module 206, where content to produce based on the defined context associated with the user interactions and a maintained state of communications between the user and the stateful context-based interaction engagement device is selected. An applicable system for managing production of content based on contexts associated with user interactions and states of communications, such as the stateful context-based user interaction management systems described in this paper, can select content to produce based on the defined context associated with the user interactions and a maintained state of communications between the user and the stateful context-based interaction engagement device. Additionally, content to produce can be selected based on the defined content and a maintained state according to stateful content-based conduct production rules.

The flowchart 200 continues to module 208, where the stateful context-based interaction engagement device is caused to produce the selected content based on the user interactions. An applicable system for managing production of content based on contexts associated with user interactions and states of communications, such as the stateful context-based user interaction management systems described in this paper, can cause the stateful context-based interaction engagement device to produce the selected content based on the user interactions. The stateful context-based interaction engagement device can be caused to produce the selected content by providing either or both the selected content and a content production command to the stateful context-based interaction engagement device.

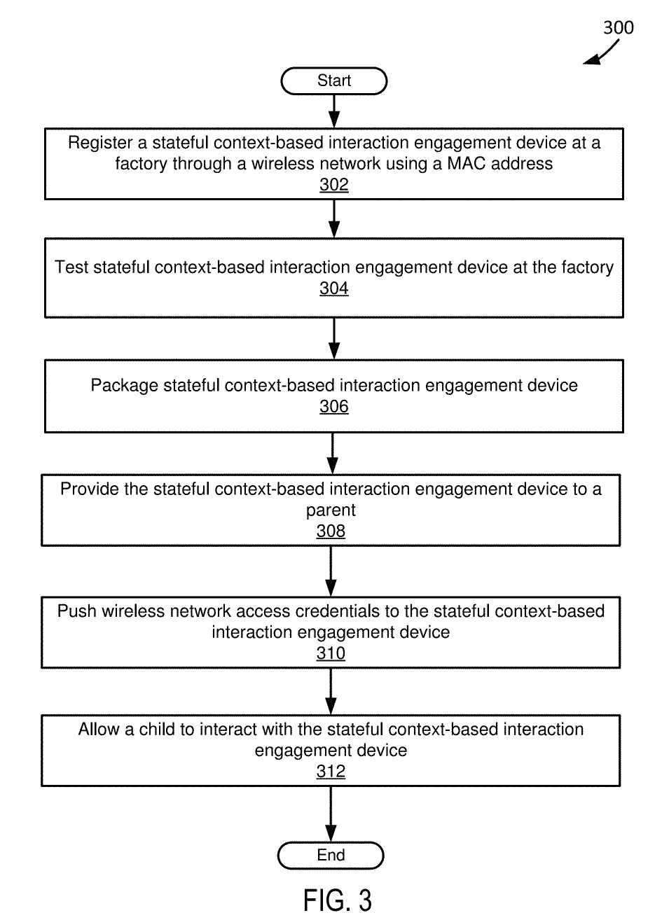

FIG. 3 depicts a flowchart 300 of an example of a method for operating a stateful context-based interaction engagement device. The flowchart 300 begins at module 302, where a stateful context-based interaction engagement device is registered at a factory through a wireless network using a MAC address. In registering a stateful context-based interaction engagement device, the stateful context-based interaction engagement device can join a wireless network at a factory and provide its MAC address. Further, in registering a stateful context-based interaction engagement device, can be registered while it is a printed circuit board without being integrated with a housing.

The flowchart 300 continues to module 304, where the stateful context-based interaction engagement device is tested at the factory. The stateful context-based interaction engagement device can be tested in a series of tests. For example, the stateful context-based interaction engagement device can be tested in a first test where an audio codec of the stateful context-based interaction engagement device is tested. Further in the example, the stateful context-based interaction engagement device can be tested in a second test after the first test, where a series of tones are reproduced at the stateful context-based interaction engagement device to ensure a speaker of the stateful context-based interaction engagement device is functioning properly.

The flowchart 300 continues to module 306, where the stateful context-based interaction engagement device is packaged at the factory. A quality control scan can be performed at the factory to ensure the stateful context-based interaction engagement device is properly packaged at the factory. The flowchart 300 continues to module 308, where the stateful context-based interaction engagement device is provided to a parent. The stateful context-based interaction engagement device can be provided after a parent purchases the stateful context-based interaction engagement device either at a physical location or through an online retailer.

The flowchart 300 continues to module 310, where wireless network access credentials are pushed to the stateful context-based interaction engagement device. Wireless network access credentials can be for a wireless network of the parent or an applicable wireless network within range of the stateful context-based interaction engagement device after it is powered on. Wireless network access credentials can be input by a parent and subsequently pushed to the stateful context-based interaction engagement device to allow for the stateful context-based interaction engagement device to automatically authenticate for a wireless network. If the stateful context-based interaction engagement device is unable to access a wireless network after wireless network access credentials are pushed to the stateful context-based interaction engagement device, then the stateful context-based interaction engagement device can enter a configuration mode, wherein a user has to configure the stateful context-based interaction engagement device to access a wireless network again.

The flowchart 300 continues to module 312, where a child is allowed to interact with the stateful context-based interaction engagement device. In allowing a child to interact with the stateful context-based interaction engagement device, a child can give the stateful context-based interaction engagement device a name. Additionally, in allowing a child to interact with the stateful context-based interaction engagement device, a microphone of the stateful context-based interaction engagement device can be calibrated specifically for the child. Optionally, the flowchart 300 can include resetting the stateful context-based interaction engagement device. In resetting the stateful context-based interaction engagement device, anything saved for a user associated with the stateful context-based interaction engagement device, e.g. the child, is erased, potentially including data both stored at the stateful context-based interaction engagement device and remote from the stateful context-based interaction engagement device.

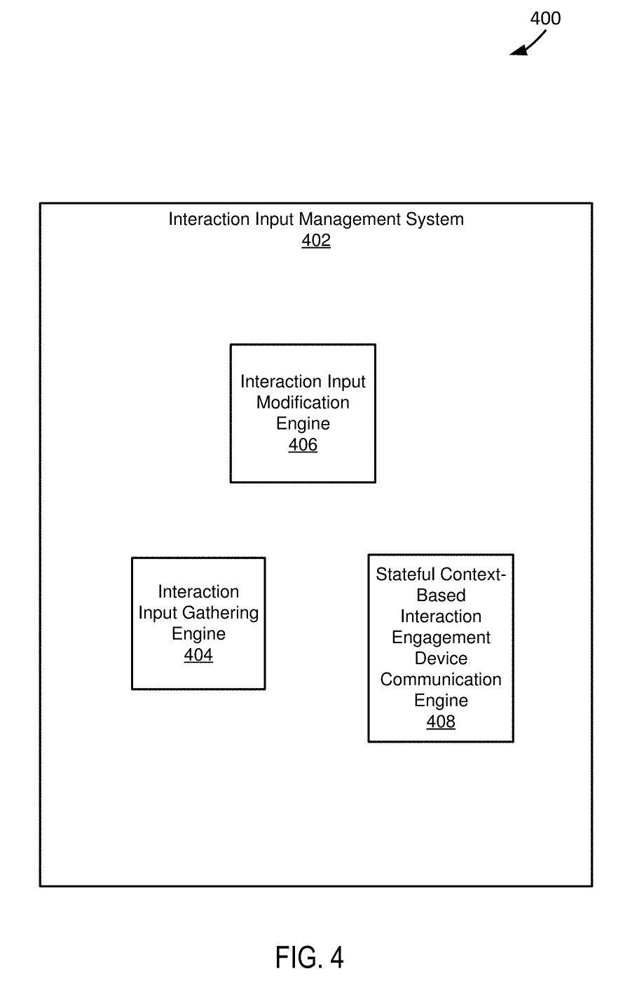

FIG. 4 depicts a diagram 400 of an interaction input management system 402. The interaction input management system 402 is intended to represent a system that functions to manage interaction input for use in presenting content to a user based on contexts associated with interactions and a state of communications between the user and a context-based interaction engagement device. The interaction input management system 402 can be implemented as part of an applicable system for managing production of content according to user interactions, such as the stateful context-based user interaction management systems described in this paper. Additionally, the interaction input management system 402 can be implemented at a stateful context-based interaction engagement device.

In managing interaction input, the interaction input management system 402 gathers interaction input. For example, the interaction input management system 402 can gather interaction input generated by a microphone. Additionally, in managing interaction input, the interaction input management system 402 can modify gathered interaction input. For example, the interaction input management system 402 can sample a voice recording stream to generate modified interaction input. Further, in managing interaction input, the interaction input management system 402 can provide either or both interaction input and modified interaction input to an applicable system for managing production of content according to contexts and a state of communications, such as the stateful context-based user interaction management systems described in this paper.

The interaction input management system 402 shown in FIG. 4 includes an interaction input gathering engine 404, an interaction input modification engine 406, and a stateful context-based interaction engagement device communication engine 408. The interaction input gathering engine 404 is intended to represent an engine that functions to gather interaction input. The interaction input gathering engine 404 can gather interaction input from an applicable mechanism for generating interaction input based on user interactions with a stateful context-based interaction engagement device. For example, the interaction input gathering engine 404 can gather an audio stream generated by a microphone from utterances made by a user in interacting with a stateful context-based interaction engagement device. The interaction input gathering engine 404 can either store gathered interaction input at a stateful context-based interaction engagement device or refrain from storing gathered interaction input at the stateful context-based interaction engagement device. By refraining from storing gathered interaction input at a stateful context-based interaction engagement device, the interaction input gathering engine 404 reduces memory requirements of the stateful context-based interaction engagement device, thereby reducing the overall cost of the device.

The interaction input modification engine 406 is intended to represent an engine that functions to modify gathered interaction input. The interaction input modification engine 406 can modify interaction input for purposes of transmitting at least portions of the interaction input through a network. For example, the interaction input modification engine 406 can sample an audio stream represented as interaction input to generate modified interaction input and for purposes of transmitting the samples of the audio stream through a wireless network. Further in the example, the interaction input modification engine 406 can sample the audio stream at a frequency of 16 MHz. The interaction input modification engine 406 can modify interaction input in real-time as the interaction input is generated and gathered.

In a specific implementation, the interaction input modification engine 406 functions to modify interaction input by encrypting the interaction input. For example, the interaction input modification engine 406 can encrypt an audio stream representing interactions by a user for purposes of transmitting the audio stream to a remote destination. The interaction input modification engine 406 can use 128 bit or 256 bit encryption mechanisms to encrypt interaction input. Additionally, the interaction input modification engine 406 can use rolling keys to encrypt interaction input.

Referring back to FIG. 4, the stateful context-based interaction engagement device communication engine 408 is intended to represent an engine at a context-based interaction engagement device that functions to transmit data to and receive data from a remote destination/source. The stateful context-based interaction engagement device communication engine 408 can transmit either or both interaction input and modified interaction input. For example, the stateful context-based interaction engagement device communication engine 408 can provide encrypted interaction input to a remote destination. Either or both interaction input and modified interaction input provided by the stateful context-based interaction engagement device communication engine 408 to a remote destination can be used to determine, at the remote destination, content to cause a context-based interaction engagement device to produce. Additionally, the stateful context-based interaction engagement device communication engine 408 can provide interaction input and modified interaction input as part of an SIP voice-only call.

In a specific implementation the stateful context-based interaction engagement device communication engine 408 functions to transmit data to and receive data from a remote destination/source through a wireless network. For example, the stateful context-based interaction engagement device communication engine 408 can transmit interaction input over a WiFi connection. Further in the example, the stateful context-based interaction engagement device communication engine 408 can receive content to produce over the WiFi connection.

In a specific implementation, the stateful context-based interaction engagement device communication engine 408 functions to transmit an audio stream of utterances a user makes, as part of interaction input, in interacting with a stateful context-based interaction engagement device. The stateful context-based interaction engagement device communication engine 408 can transmit an audio stream in real-time. Additionally, the stateful context-based interaction engagement device communication engine 408 can transmit an audio stream as part of an SIP voice-only call. In transmitting an audio stream in real-time, content can be produced at a stateful context-based interaction engagement device based on the audio-stream with a delay on only network latency. For example, in transmitting an audio stream in real-time, either or both content to produce and a content production command can be received within 10 ms of either or both a time the audio stream is generated and a time at which the audio stream is transmitted in real-time.

In an example of operation of the example interaction input management system shown in FIG. 4, the interaction input gathering engine 404 gathers interaction input generated at a stateful context-based interaction engagement device in response to user interactions with the device. In the example of operation of the example system shown in FIG. 4, the interaction input modification engine 406 modifies the interaction input gathered by the interaction input gathering engine 404 to generate modified interaction input for purposes of transmitting the modified interaction input to a remote destination. Further, in the example of operation of the example system shown in FIG. 4, the stateful context-based interaction engagement device communication engine 408 transmits the modified interaction input to the remote destination for purposes of determining, at the remote destination, content to produce at the stateful context-based interaction engagement device.

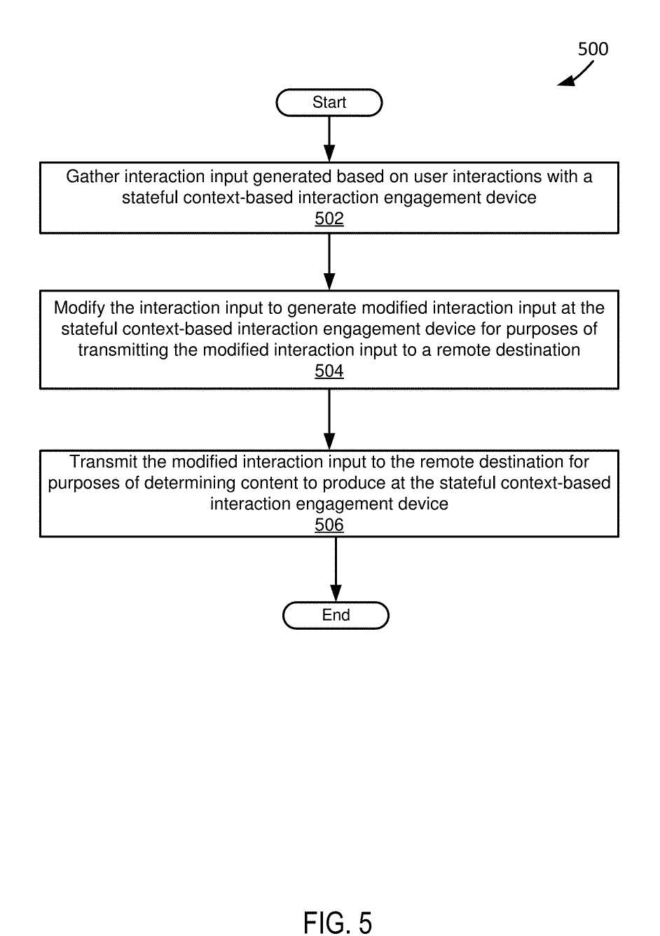

FIG. 5 depicts a flowchart 500 of an example of a method for transmitting interaction input for use in determining content to produce at a stateful context-based interaction engagement device. The flowchart 500 begins at module 502, where interaction input generated based on user interactions with a stateful context-based interaction engagement device is gathered. An applicable engine for gathering interaction input, such as the interaction input gathering engines described in this paper, can gather interaction input generated based on user interactions with a stateful context-based interaction engagement device. Interaction input can be gathered from an applicable mechanism for generating interaction input. For example, an audio recording of utterances made by a user in interacting with a stateful context-based interaction engagement device can be gathered from a microphone implemented at the stateful context-based interaction engagement device.

The flowchart 500 continues to module 504, where the interaction input is modified to generate modified interaction input at the stateful context-based interaction engagement device for purposes of transmitting the modified interaction input from the stateful context-based interaction engagement device to a remote destination. A remote destination can include an applicable system for managing production of content at a stateful context-based interaction engagement device based on user interactions, such as the stateful context-based user interaction management systems described in this paper. An applicable engine for modifying interaction input, such as the interaction input modification engines described in this paper, can modify the interaction input to generate modified interaction input for purposes of transmitting the modified interaction input from the stateful context-based interaction engagement device. In modifying the interaction input, the interaction input can be sampled and the samples of the interaction input can form the modified interaction input. Additionally, in modifying the interaction input, the interaction input can be encrypted to created modified interaction input.

The flowchart 500 continues to module 506, where the modified interaction input is transmitted to the remote destination. An applicable engine for sending data from and receiving data at a stateful context-based interaction engagement device, such as the stateful context-based interaction engagement device communication engines described in this paper, can transmit the modified interaction input to the remote destination. The modified interaction input can be transmitted to the remote destination through, at least in part, a wireless network. For example, the modified interaction input can be transmitted from the stateful context-based interaction engagement device over a WiFi connection between the stateful context-based interaction engagement device and a network device included in a basic service set.

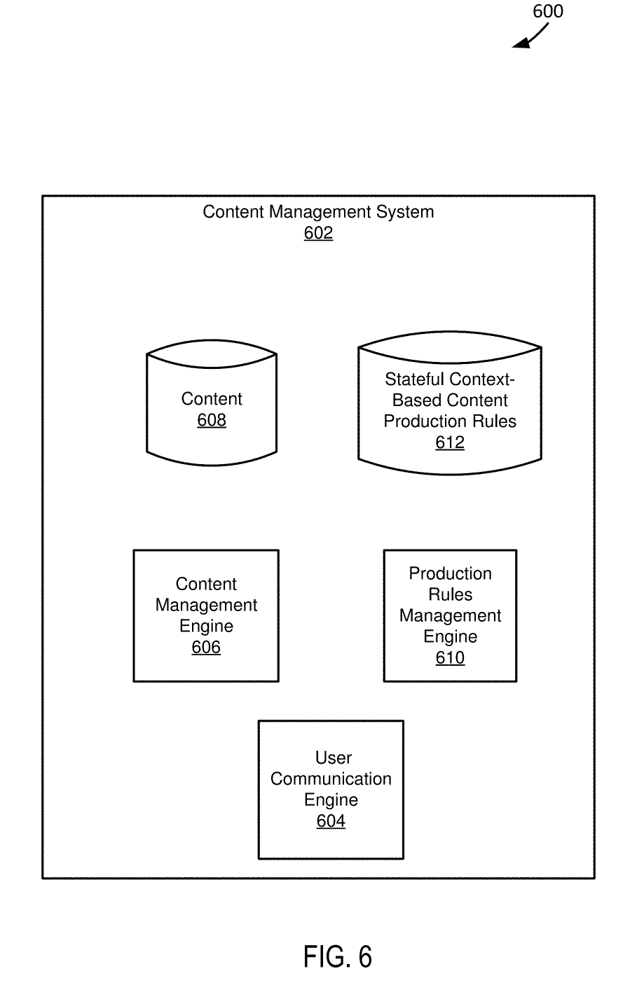

FIG. 6 depicts a diagram 600 of an example of a content management system 602. The content management system 602 is intended to response a system that function to manage content for production at a stateful context-based interaction engagement device in response to user interactions with the device. The content management system 602 can be included as part of an applicable system for managing production of content according to user interactions, such as the stateful context-based user interaction management systems described in this paper. In managing content for production at a stateful context-based interaction engagement device, the content management system 602 can maintain content to be produced at the stateful context-based interaction engagement device. For example, the content management system 602 can maintain audio provided by a parent to be produced for a student as part of a lesson plan. Additionally, in managing content for production at a stateful context-based interaction engagement device, the content management system 602 can maintain stateful context-based content production rules for content.

The content management system 602 includes a user communication engine 604, a content management engine 606, a content datastore 608, a production rules management engine 610, and a stateful context-based content production rules datastore 612. The user communication engine 604 is intended to represent an engine that functions to communicate with a user regarding presentation of content at a stateful context-based interaction engagement device. In communicating with a user, the user communication engine 604 can receive input regarding specific content to present. For example, the user communication engine 604 can receive input including specific audio content to present to a student from a teacher. In another example, the user communication engine 604 can receive input from a parent indicating modifications to make to content for presentation to a child of the parent.

In a specific implementation, the user communication engine 604 functions to receive input regarding stateful context-based content production rules for controlling production of content to a user by a stateful context-based interaction engagement device. In receiving input regarding stateful context-based content production rules, the user communication engine 604 can receive input indicating a specific stateful context-based content production rule to use in controlling reproduction of specific content. For example, the user communication engine 604 can receive input indicating to produce content associated with a grade three reading level after a user has achieved a grade two reading level. Further, in receiving input regarding stateful context-based content production rules, the user communication engine 604 can receive input indicating modifications to make to specific stateful context-based content production rules. For example, the user communication engine 604 can receive input indicating to modify a stateful context-based content production rule to include not producing specific content for a child of a parent.

Referring back to FIG. 6, the content management engine 606 is intended to represent an engine that functions to manage content produced at a stateful context-based interaction engagement device in response to user interactions with the device. In managing content, the content management engine 606 can either or both generate and update content data used to reproduce content at a stateful context-based interaction engagement device. Content data can include applicable data used to produce content at a stateful context-based interaction engagement device. For example, content data can include an MP3 file used to reproduce an audio recording. The content management engine 606 can maintain content data at either or both a stateful context-based interaction engagement device or a location remote from a stateful context-based interaction engagement device. For example, the content management engine 606 can maintain content data at a cloud-based location remote from a stateful context-based interaction engagement device.

In a specific implementation, the content management engine 606 functions to manage content according to user input. In managing content according to user input, the content management engine 606 can receive content as part of user input from a user. For example, the content management engine 606 can receive content as part of a lesson plan from a teacher of a student. Further, in managing content according to user input, the content management engine 606 can edit content according to user input. For example, if a parent specifies removing certain words from an audio file as part of user input, then the content management engine 606 can edit the audio file to remove the words from the audio file.

In a specific implementation, the content management engine 606 functions to gather content for production at a stateful context-based interaction engagement device from an applicable source. For example, the content management engine 606 can gather audio files from a publicly accessible repository of content. In another example, the content management engine 606 can crowdsource content. In crowdsourcing content, the content management engine 606 can gather content from a group of parents of children who use stateful context-based interaction engagement devices. In gathering content for production, the content management engine 606 can suggest to a user content to be produced at a stateful context-based interaction engagement device. For example, the content management engine 606 can suggest to a parent content to be produced at a stateful context-based interaction engagement device utilized by a child of the parent.

Referring back to FIG. 6, the content datastore 608 is intended to represent a datastore that functions to store content data for use in producing content at a stateful context-based interaction engagement device. The content datastore 608 can be maintained, at least in part, remote from a stateful context-based interaction engagement device. Additionally, the content datastore 608 can be maintained, at least in part, at a stateful context-based interaction engagement device. Content data stored in the content datastore 608 can be maintained based on input received from a user. For example, a parent can provide content data to use in producing content at a stateful context-based interaction engagement device, and content datastore 608 can be configured to store the provided content data.

The production rules management engine 610 is intended to represent an engine that functions to manage stateful context-based content production rules for use in controlling production of content at a stateful context-based interaction engagement device. In managing stateful context-based content production rules, the production rules management engine 610 can generate and update stateful context-based content production rules. For example, the production rules management engine 610 can create a stateful context-based content production rules for third grade reading level content to include production of the content when a user reaches a third grade reading level. In another example, the production rules management engine 610 can modify stateful context-based content production rules for specific content to indicate not production the content for a specific user. In generating and updating stateful context-based content production rules for specific content indicating to produce the content when a user makes utterances in a semantic construct associated with the specific content.

In a specific implementation, the production rules management engine 610 functions to maintain stateful context-based content production rules based on input received from a user. In managing stateful context-based content production rules according to user input, the production rules management engine 610 can receive stateful context-based content production rules as part of user input from a user. For example, the production rules management engine 610 can receive rules for producing content as part of a lesson plan from a teacher. Further, in managing stateful context-based content production rules according to user input, the production rules management engine 610 can edit stateful context-based content production rules according to user input. For example, if a parent specifies allowing their child to access specific content then the production rules management engine 610 can edit stateful context-based content production rules for the specific content to include allowing the child to access the specific content through a stateful context-based interaction engagement device.

Referring back to FIG. 1, the stateful context-based content production rules datastore 612 is intended to represent a datastore that functions to store stateful context-based content production rules data indicating stateful context-based content production rules. Stateful context-based content production rules indicated by stateful context-based content production rules data stored in the stateful context-based content production rules datastore 612 can be used in controlling production of content at a stateful context-based interaction engagement device. Additionally, stateful context-based content production rules data stored in the stateful context-based content production rules datastore 612 can be generated based on input received from a user associated with a stateful context-based interaction engagement device, e.g. a parent of a child.

In an example of operation of the example content management system 602 shown in FIG. 6, the user communication engine 604 received input from a user regarding production of content at a stateful context-based interaction engagement device. In the example of operation of the example system shown in FIG. 6, the content management engine 606 maintains content data stored in the content datastore 608, for use in producing content at the stateful context-based interaction engagement device. Further, in the example of operation of the example system shown in FIG. 6, the production rules management engine 610 maintains stateful context-based content production rules data stored in the stateful context-based content production rules datastore 612, for use in controlling production of content at the stateful context-based interaction engagement device.

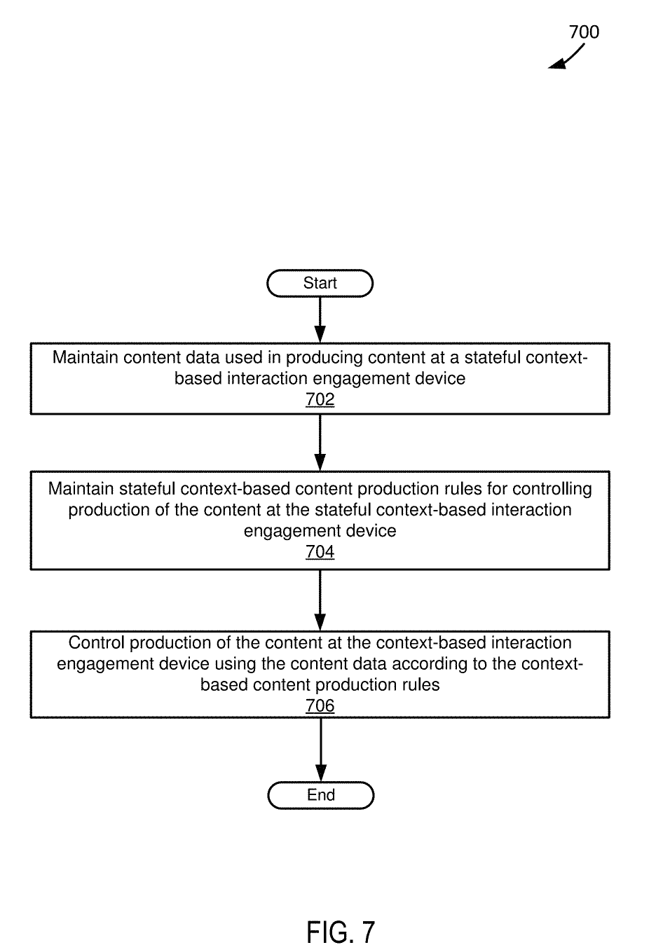

FIG. 7 depicts a flowchart 700 of an example of a method for maintaining data used in controlling production of content at a stateful context-based interaction engagement device. The flowchart 700 begins at module 702, where content data used in producing content at a stateful context-based interaction engagement device is maintained. An applicable engine for maintaining content data for use in producing content at a stateful context-based interaction engagement device, such as the content management engines described in this paper, can maintain content data used in production content at a stateful context-based interaction engagement device. Content data can be maintained according to user input. For example, a user associated with a stateful context-based interaction engagement device can provide content to be produced at the device.

The flowchart 700 continues to module 704, where stateful context-based content production rules for the content are maintained. Maintained stateful context-based content production rules can be used in controlling productions of the content at the stateful context-based interaction engagement device. For example, stateful context-based content production rules for the content can indicate producing the content if user utterances form a particular semantic construct. An applicable engine for maintaining stateful context-based content production rules, such as the production rules management engines described in this paper, can maintain stateful context-based content production rules for the content.

The flowchart 700 continues to module 706, where production of the content at the context-based interaction engagement device is controlled using the content data based on the stateful context-based content production rules. An applicable system for managing production of content at a stateful context-based interaction engagement device according to contexts associated with user interactions with a stateful context-based interaction engagement device can control production of the content at the context-based interaction engagement device using the content data based on the stateful context-based content production rules. For example, the content data can be provided to the stateful context-based interaction engagement device if it is determined to produce the content at the device according to the stateful context-based content production rules.

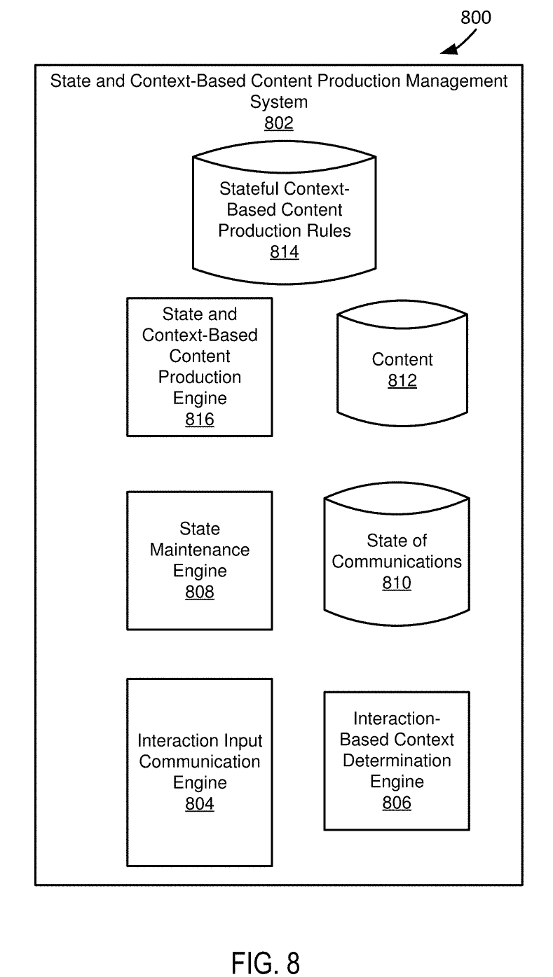

FIG. 8 depicts a diagram 800 of an example of a state and context-based content production management system 802. The state and context-based content production management system 802 is intended to represent a system that functions to manage production of content at a stateful context-based interaction engagement device according to user interaction with the device. The state and context-based content production management system 802 can be implemented as part of an applicable system that controls production of content at a stateful context-based interaction engagement device based on user interactions with the device, such as the stateful context-based user interaction management systems described in this paper. The state and context-based content production management system 802 can be implemented, at least in part, at a stateful context-based interaction engagement device.

In a specific implementation, the state and context-based content production management system 802 functions to determine content to produce at a stateful context-based interaction engagement device. In determining content to produce at a stateful context-based interaction engagement device, the state and context-based content production management system 802 can determine content to produce based on a determined context of communications between the device and a user. For example, if a stateful context-based interaction engagement device is at a specific location, then the state and context-based content production management system 802 can determine content to produce based on the specific location of the device. Further, in determining content to produce at a stateful context-based interaction engagement device, the state and context-based content production management system 802 can determine content to produce based on a state of communications between a user and the stateful context-based interaction engagement device. For example, if a state indicates a user is continuing to ask the same question, then the state and context-based content production management system 802 can determine a response to produce based on the user continuing to ask the same question.

Referring back to FIG. 8, the state and context-based content production management system 802 includes an interaction input communication engine 804, an interaction-based context determination engine 806, a state maintenance engine 808, a state of communications datastore 810, a content datastore 812, a stateful context-based content production rules datastore 814, and a state and context-based content production engine 816. The interaction input communication engine 804 is intended to represent an engine that functions to receive interaction input. The interaction input communication engine 804 can receive data through, at least in part, a wireless network. For example, interaction input can be transmitted from a stateful context-based interaction engagement device over a wireless connection formed between the device and an access point. Additionally, the interaction input communication engine 804 can receive modified interaction input. For example, the interaction input communication engine 804 can receive an encrypted and sampled audio stream of utterances a user makes in interacting with a stateful context-based interaction engagement device.

The interaction-based context determination engine 806 is intended to represent an engine that determines contexts associated with user interactions with a stateful context-based interaction engagement device. For example, the interaction-based context determination engine 806 can determine a location of a stateful context-based interaction engagement device when a user interacts with the stateful context-based interaction engagement device. The interaction-based context determination engine 806 can determine contexts associated with user interactions with a stateful context-based interaction engagement device based on either or both interaction input and modified interaction input. For example, the interaction-based context determination engine 806 can determine a user activated a specific actuator on a stateful context-based interaction engagement device from interaction input generated based on the interaction of the user activating the specific actuator. Additionally, the interaction-based context determination engine 806 can determine contexts associated with user interactions with a stateful context-based interaction engagement device based on content that is produced at the stateful context-based interaction engagement device. For example, the interaction-based context determination engine 806 can determine a stateful context-based interaction engagement device produced specific responses to questions for a user.

In a specific implementation, the interaction-based context determination engine 806 functions to define semantic constructs for utterances made by a user as part of determining contexts associated with user interactions of the user with a stateful context-based interaction engagement device. In defining semantic constructs, the interaction-based context determination engine 806 can use an applicable speech recognition method or mechanism. The interaction-based context determination engine 806 can use a rule-based mechanism to determine a semantic construct of words spoken by a user. Additionally, the interaction-based context determination engine 806 can use natural language processing or structured machine language processing to determine a semantic construct of words spoken by a user in interacting with a stateful context-based interaction engagement device. For example, the interaction-based context determination engine 806 can apply machine learning to previous utterances made by a user to develop a natural language processing mechanism specific to the user, for utilization in determining semantic constructs of utterances made by the user. Further, the interaction-based context determination engine 806 can first apply a rule-based mechanism and then natural language processing to determine a semantic construct of words spoken by a user in interacting with a stateful context-based interaction engagement device.

Referring back to FIG. 8, the state maintenance engine 808 is intended to represent an engine that maintains a state of communications between a user and a stateful context-based interaction engagement device. The state maintenance engine 808 can maintain a state of communications based on determined contexts associated with user interactions with a stateful context-based interaction engagement device. For example, if a user spoke a specific phrase in interacting with a stateful context-based interaction engagement device, then the state maintenance engine 808 can update a state of communications to indicate the user spoke the specific phrase in interacting with the stateful context-based interaction engagement device. In another example, if specific content is produced at a stateful context-based interaction engagement device in response to user interactions with the device, then the state maintenance engine 808 can update a state of communications to indicate the specific content was produce at the stateful context-based interaction engagement device for the user. In maintaining a state of communications, the state maintenance engine 808 can generate and update state of communications data.

In a specific implementation, the state maintenance engine 808 maintains a dialog tree as part of maintaining a state of communication between a user and a stateful context-based interaction engagement device. The state maintenance engine 808 can maintain a dialog tree based on determined contexts associated with user interactions with a stateful context-based interaction engagement device. For example, if it is determined a user uttered a specific phrase in interacting with a stateful context-based interaction engagement device, then the state maintenance engine 808 can update a dialog tree to indicate the user uttered the specific phrase as part of a conversation the user has with the stateful context-based interaction engagement device. In maintaining a dialog tree, the state maintenance engine 808 can generate and update state of communications data.

Referring back to FIG. 8, the state of communications datastore 810 is intended to represent a datastore that functions to store state of communications data. State of communications data stored in the state of communications datastore 810 can indicate a state of communications between a user and a stateful context-based interaction engagement device. Additionally, state of communications data stored in the state of communications datastore 810 can indicate a maintained dialog tree. State of communications data stored in the state of communications datastore 810 can be generated and updated according to determined contexts associated with user interactions with a stateful context-based interaction engagement device.

The content datastore 812 is intended to represent an applicable datastore that functions to store content data, such as the content datastores described in this paper. Content data stored in the content datastore 812 can be used to produce content at a stateful context-based interaction engagement device. For example, content data stored in the content datastore 812 can include an audio file used to produce specific audio at a stateful context-based interaction engagement device.

The stateful context-based content production rules datastore 814 is intended to represent an applicable datastore that functions to store stateful context-based content presentation rules data, such as the stateful context-based content presentation rules datastores described in this paper. The stateful context-based content production rules datastore 814 can store data indicating stateful context-based content presentation rules for controlling production of content at a stateful context-based interaction engagement device. Stateful context-based content presentation rules data stored in the stateful context-based content production rules datastore 814 can be generated and updated based on user input.

The state and context-based content production engine 816 is intended to represent an engine that functions to control production of content at a stateful context-based interaction engagement device based on state and context. The state and context-based content production engine 816 can control production of content at a stateful context-based interaction engagement device based on a determined context associated with user interaction with the device. For example, if a user utters a specific question, then the state and context-based content production engine 816 can determine to produce an answer to the specific question at a stateful context-based interaction engagement device. Additionally, the state and context-based content production engine 816 can control production of content at a stateful context-based interaction engagement device based on a state of communications between a user and a stateful context-based interaction engagement device. For example, if a user continues to ask the same question, as indicated by a state of communications, then the state and context-based content production engine 816 can determine to modify an answer to the question produced at a stateful context-based interaction engagement device based on the user continuing to ask the same question.

In a specific implementation, the state and context-based content production engine 816 functions to use stateful context-based content production rules in determining content to produce at a stateful context-based interaction engagement device. In using stateful context-based content production rules to determine which content to produce, the state and context-based content production engine 816 can use either or both a determined context associated with user interactions with a stateful context-based interaction engagement device and a state of communications to determine content to produce. For example, if a user utters a specific phrase in interacting with a stateful context-based interaction engagement device, and stateful context-based content production rules specify producing specific audio when a user utters a specific phrase, then the state and context-based content production engine 816 can determine to produce the specific audio.

In a specific implementation, the state and context-based content production engine 816 functions to cause a stateful context-based interaction engagement device to produce determined content. In causing a stateful context-based interaction engagement device, the state and context-based content production engine 816 can send either or both specific content data and a content production command to the stateful context-based interaction engagement device. For example, the state and context-based content production engine 816 can send to a stateful context-based interaction engagement device specific content data which serves as a command to produce the specific content at the device.

In an example of operation of the example state and context-based content production management system 802 shown in FIG. 8, the interaction input communication engine 804 receives interaction input. In the example of operation of the example system shown in FIG. 8, the interaction-based context determination engine 806 determines a context associated user interactions with a stateful context-based interaction engagement device using the interaction input. Further, in the example of operation of the example system shown in FIG. 8, state maintenance engine 808 maintains a state of communications between the user and the stateful context-based interaction engagement device using the determined context associated with the user interaction. In the example of operation of the example system shown in FIG. 8, the state and context-based content production engine 816 determines content for the stateful context-based interaction engagement device to produce based on the state of communications and the determined context. Additionally, in the example of operation of the example system shown in FIG. 8, the state and context-based content production engine 816 causes the stateful context-based interaction engagement device to produce the determined content.

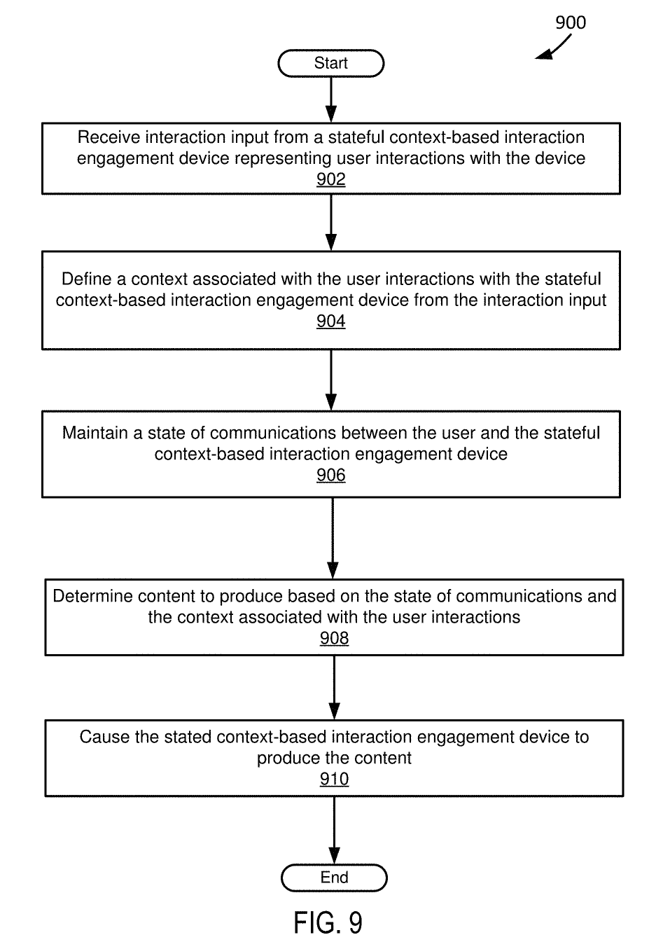

FIG. 9 depicts a flowchart 900 of an example of a method for producing content at a stateful context-based interaction engagement device based on user interactions with the device. The flowchart 900 begins at module 902, where interaction input is received from a stateful context-based interaction engagement device representing user interactions with the device. An applicable engine for communicating with a stateful context-based interaction engagement device, such as the interaction input communication engines described in this paper, can receive interaction input from a stateful context-based interaction engagement. Received interaction input, can include modified interaction input. For example, received interaction input can include an encrypted audio stream transmitted from a stateful context-based interaction engagement device in real-time.

The flowchart 900 continues to module 904, where a context associated with the user interactions with the stateful context-based interaction engagement device are defined from the interaction input. An applicable engine for defining a context associated with user interactions with a stateful context-based interaction engagement device, such as the interaction-based context determination engines described in this paper, can define a context associated with the user interactions with the stateful context-based interaction engagement device. In defining a context associated with the user interactions with the stateful context-based interaction engagement device, a semantic construct can be associated or otherwise defined for the user interactions.

The flowchart 900 continues to module 906, where a state of communication between the user and the stateful context-based interaction engagement device are maintained. An applicable engine for maintaining a state of communications between a user and a stateful context-based interaction engagement device, such as the state maintenance engines described in this paper, can maintain a state of communications between the user and the stateful context-based interaction engagement device. A state of communications between the user and the stateful context-based interaction engagement device can be maintained using the defined context associated with the user interactions with the stateful context-based interaction engagement device.

The flowchart 900 continues to module 908, where content to produce at the stateful context-based interaction engagement device is determined based on the state of communications between the user and the stateful context-based interaction engagement device and the defined context associated with the user interactions with the stateful context-based interaction engagement device. An applicable engine for controlling production of content at a stateful context-based interaction engagement device, such as the state and context-based content production engines described in this paper, can determine content to produce at the stateful context-based interaction engagement device based on the state of communications between the user and the stateful context-based interaction engagement device and the defined context associated with the user interactions with the stateful context-based interaction engagement device. Content to product at the stateful context-based interaction engagement device can be determined according to stateful context-based content production rules.

The flowchart 900 continues to module 910, where the stateful context-based interaction engagement device is caused to produce the determined content. An applicable engine for controlling production of content at a stateful context-based interaction engagement device, such as the state and context-based content production engines described in this paper, can cause the stateful context-based interaction engagement device to produce the content. Either or both content data used to produce the content and a content production command can be sent to the stateful context-based interaction engagement device to cause the stateful context-based interaction engagement device to produce the content.

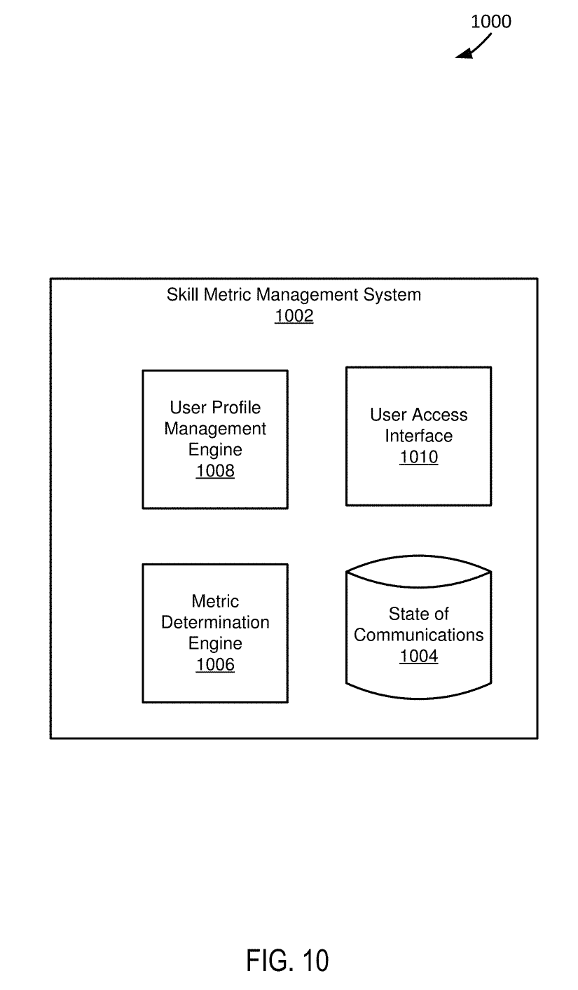

FIG. 10 depicts a diagram 1000 of an example of a skill metric management system 1002. The skill metric management system 1002 is intended to represent a system that functions to maintain skill metrics for users based on communications between the users and stateful context-based interaction engagement devices. The skill metric management system 1002 can be implemented as part of an applicable system that controls production of content at a stateful context-based interaction engagement device based on user interactions with the device, such as the stateful context-based user interaction management systems described in this paper. The skill metric management system 1002 can be implemented, at least in part, at a stateful context-based interaction engagement device.

In a specific implementation, the skill metric management system 1002 determines metrics related to communications of a user and a stateful context-based interaction engagement device based on either or both a state of communications and contexts associated with user interactions. For example, if a state of communications indicates a user has answered all second grade reading level questions correctly, then the skill metric management system 1002 can determine the user has a second grade reading level. In another example, if a content associated with user interactions indicates a user knows how to successfully turn on a stateful context-based interaction engagement device, then the skill metric management system 1002 can determine a user has achieved the ability to begin learning using the stateful context-based interaction engagement device.

The example skill metric management system 1002 shown in FIG. 10 includes a state of communications datastore 1004, a metric determination engine 1006, a user profile management engine 1008, and a user access interface 1010. The state of communications datastore 1004 is intended to represent an applicable datastore that functions to store state of communications data, such as the state of communications datastores described in this paper. State of communications data stored in the state of communications datastore 1004 can indicate a maintained state of communications between a user and a stateful context-based interaction engagement device.

The metric determination engine 1006 is intended to represent an engine that functions to determine metrics related to communications of a user and a stateful context-based interaction engagement device. The metric determination engine 1006 can determine metrics related to communications based on a maintained state of communications. Additionally, the metric determination engine 1006 can determine metrics related to communications based on defined contexts associated with user interactions with a stateful context-based interaction engagement device.

The user profile management engine 1008 is intended to represent an engine that functions to maintain a user profile for a user interacting with a stateful context-based interaction engagement device. A user profile maintained by the user profile management engine 1008 can be used to control production of content at a stateful context-based interaction engagement device to a user. The user profile management engine 1008 can maintain the user profile based on determined metrics related to communications. For example, if a metric indicates a child has achieved a third grade reading level, then the user profile management engine 1008 can update a user profile for the user to indicate the user is at a third grade reading level.

The user access interface 1010 serves as an interface through which a user can access either or both a user profile and determined metrics related to communications. For example, through the user access interface 1010, a parent can see the skill levels of their children as determined from metrics related to communications. In another example, through the user access interface 1010, a teacher can see the skill levels of their students as determined from metrics related to communications. The user access interface 1010 can be implemented through a native applicable or a web-based application.

In an example of operation of the example skill metric management system 1002 shown in FIG. 10, the state of communications datastore 1004 maintains state of communications data indicating a state of communications between a user and a stateful context-based interaction engagement device. In the example of operation of the example system shown in FIG. 10, the metric determination engine 1006 determines metrics relate d to communications of the user based on the state of communications indicated by the state of communications data stored in the state of communications datastore 1004. Further, in the example of operation of the example system shown in FIG. 10, the user profile management engine 1008 maintains a user profile for the user based on the determined metrics related to communications of the user. In the example of operation of the example system shown in FIG. 10, the user access interface 1010 provides an interface through which another user can view the user profile maintained by the user profile management engine 1008.

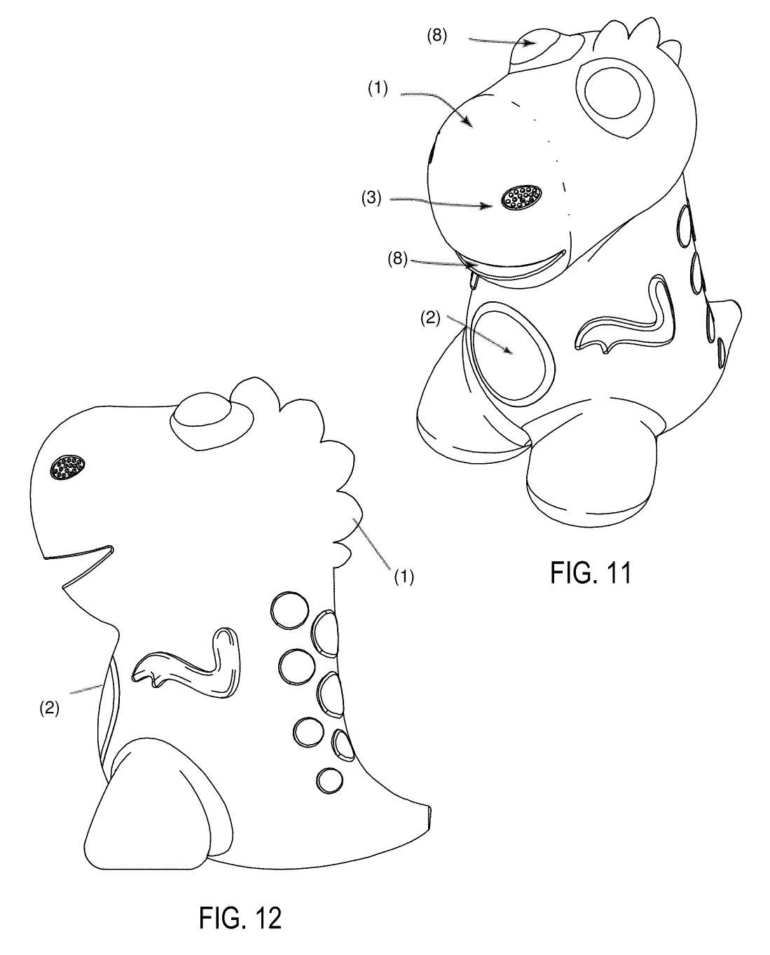

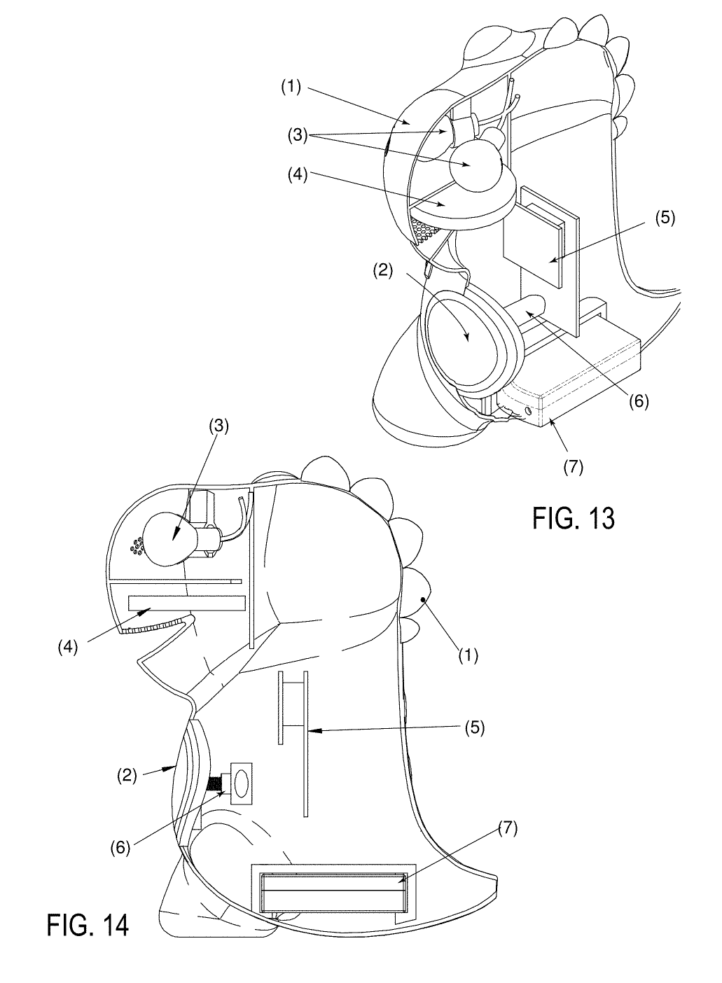

FIG. 11 shows a top perspective view of an example of a stateful context-based interaction engagement device. FIG. 12 shows a side view of an example of a stateful context-based interaction engagement device. FIG. 13 shows perspective view of a cross section of an example of a stateful context-based interaction engagement device. FIG. 14 shows a side view of a cross section of an example of a stateful context-based interaction engagement device. The example stateful context-based interaction engagement device shown in FIGS. 11-14 can be connected wirelessly to a cloud-based database. The example stateful context-based interaction engagement device includes (1) a cosmetic shell, (2) an actuating button, which is connected to a (6) pushbutton switch, which is connected to (5) a wireless-enabled printed circuit board (PCB). Also connected to the PCB are: (3) a microphone, (4) an audio speaker, and a power supply (7). A user operates the device by pressing on the (2) an actuating button, and speaking into the (3) microphone/s. (8) Decorative lights may communicate to the user device states such as ‘listening’, ‘talking’, ‘thinking’, ‘onboarding’, ‘error’, etc.

In a specific implementation, the example stateful context-based interaction engagement devices discussed in this paper act as an embedded SIP client, which collects audio streams and transmits these to the cloud via a transfer protocol such as Store and Forward, or Session Initiation Protocol (SIP). The device can use the Internet to make SIP voice-only calls. These voice calls c a n allow a user to query a knowledge engine using natural speech via a microphone, and to receive a reply as audio data played on a speaker. The user, such as a child, can press (2) a button to initiate a voice call (Push To Talk) implemented in SIP using a protocol such as, but not limited, to RFC 4964. The hardware platform can contain WiFi and audio capability. Voice calls can be directed to a purpose-specific SIP network endpoint that runs software such as, but not limited to, FreeSwitch. The device can operate on a wide variety of host networks that may use a variety of NAT or firewall functionality. The device can employ an audio codec.

In a specific implementation, encryption of the media and signaling channels may be employed to transmit data from the example stateful context-based interaction engagement devices discussed in this paper. Audio calls can be half duplex, or can be full duplex if Automatic Echo Cancellation is employed. The device can be capable of sustaining only one SIP call at any instant in time. The device is not required to receive SIP calls. The device can support only one codec. The device can support only one media session in any call.

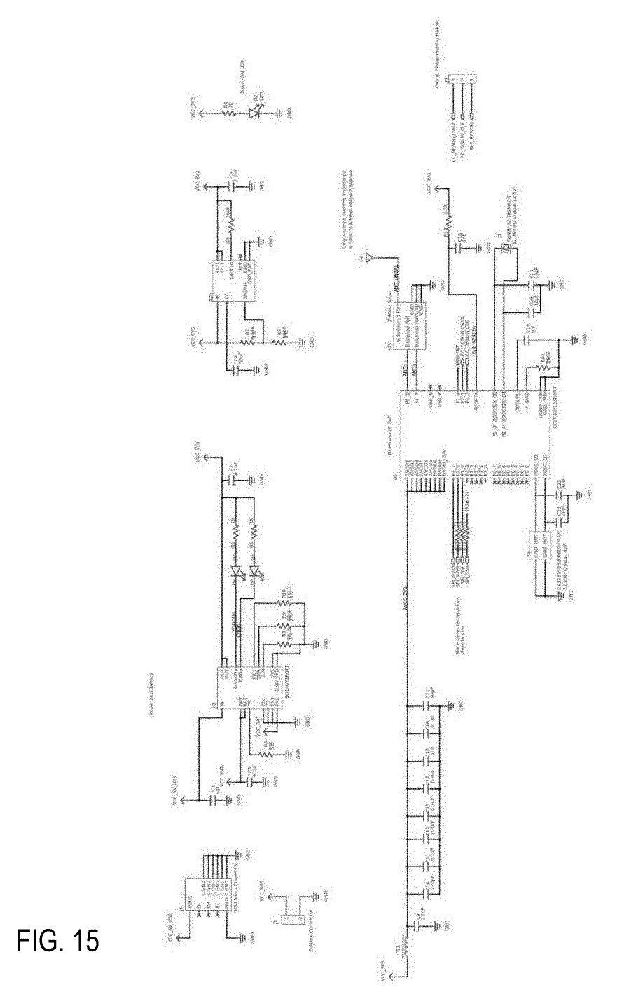

FIG. 15 depicts an electrical schematic of a printed circuit board included as part of an example stateful context-based interaction engagement device.

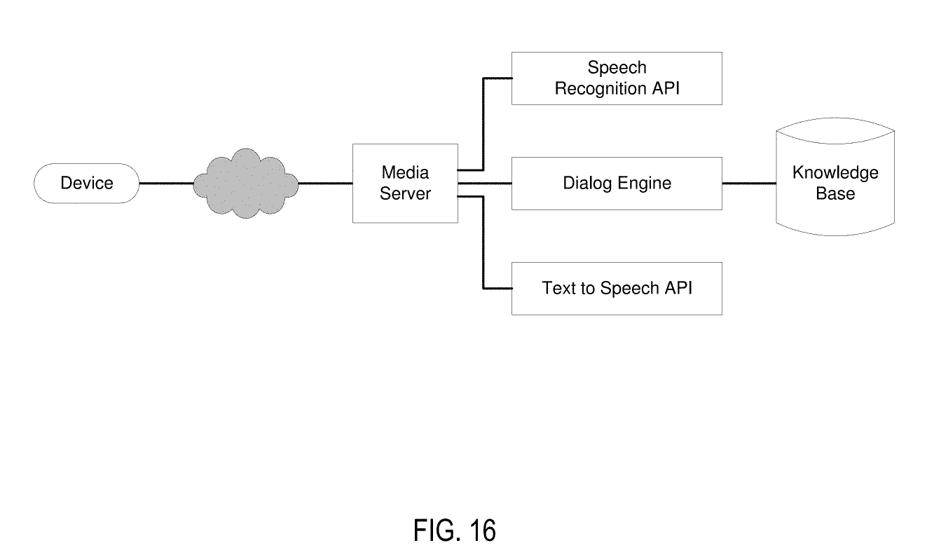

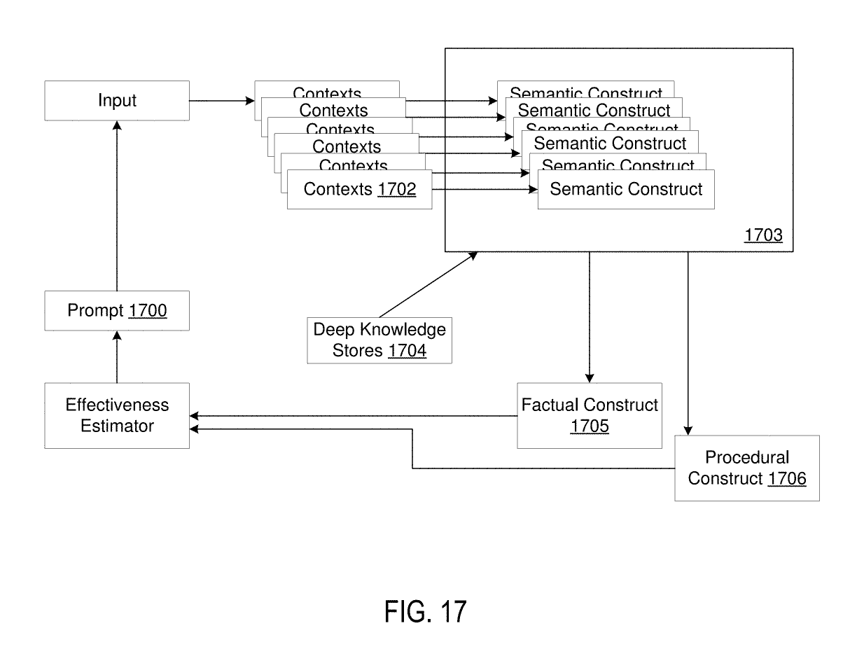

FIG. 16 depicts a diagram of an example of a system for controlling production of content at a stateful context-based interaction engagement device based on user interaction with the device. FIG. 17 depicts a diagram of an example of a stateful context-based user interaction management system. The systems shown in FIGS. 16 and 17 can include an adaptive language-based learning engine. The adaptive language-based learning engine can employ a computationally implemented method of creating, maintaining, tracking and augmenting educational context using natural or structured machine language input. The method can utilize a plurality of linguistic-cognitive contexts that encompass deep knowledge of real-world situations, a plurality of factual and procedural construct that amount to completion of learning tasks, and a method for measuring learning effectiveness as a trigger to switching linguistic-cognitive contexts. The method can comprise soliciting an input by providing a natural or structured machine language prompt (1700) to the user. In this method, each linguistic-cognitive context (1702) can further comprises deep knowledge stores (1704) and semantic constructs (1703) that comprehends nature of real-world objects and their connective relations. Each factual construct (1705) further comprises a two-way relation between a named entity and an explanatory description of such entity. The relation is used to evaluate validity of inputs. Each procedural construct (1706) further comprises a series of demonstrable steps that elicits a plurality of pathways of demonstration. The pathways marked with validity are used to evaluate validity of inputs. The method also can allow for measuring of learning effectiveness as a trigger to switching linguistic-cognitive contexts further comprises of a method to estimate learning effectiveness from validity of inputs, likelihood of false-positives, likelihood of false-negatives, and arduousness of demonstrating effectiveness by construct evaluation. Additionally, the database can include modules such as speech recognition, syntactic processing, semantic processing, knowledge tracing, and data mining.

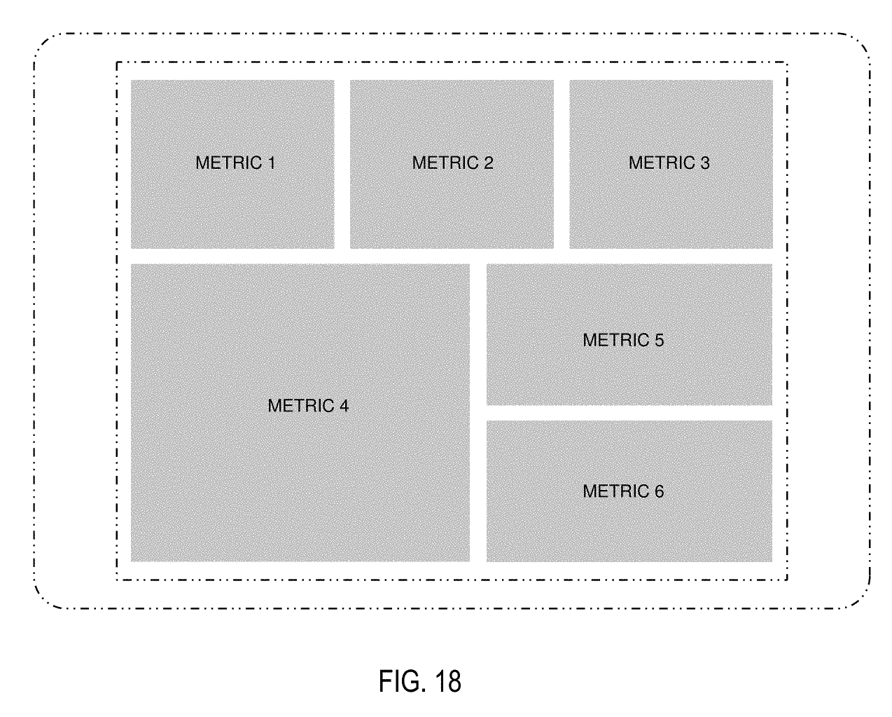

FIGS. 18-22 show example screenshots of a content management interface, titled “Parent Panel”, which allows third parties (such as guardians) to customize, configure, and navigate reports for a stateful context-based interaction engagement device. Metrics can be displayed on a dashboard that describes a child's interaction with the device.

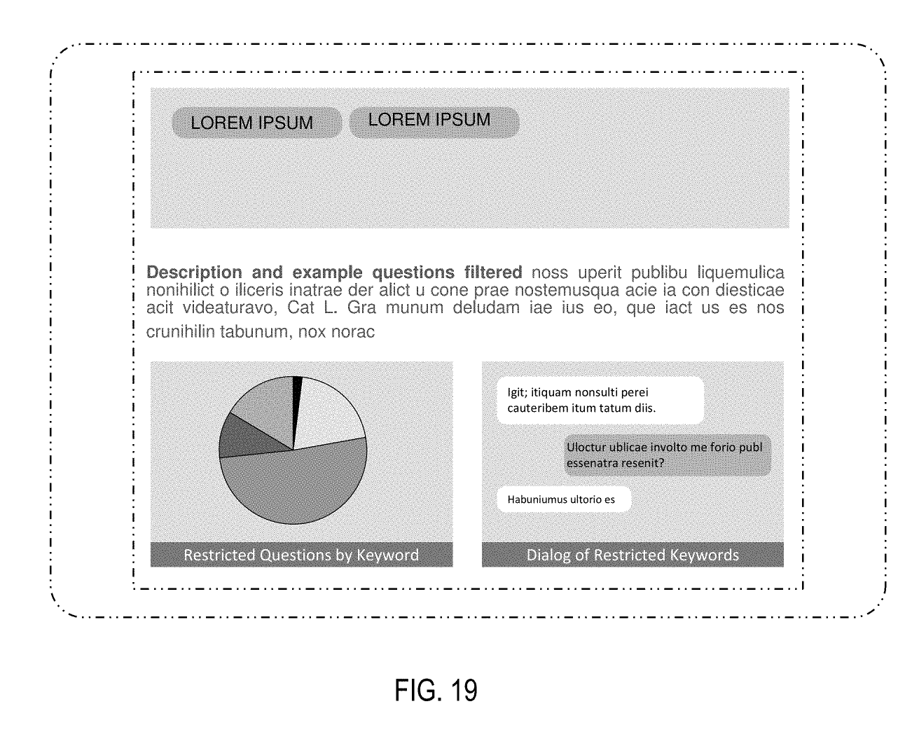

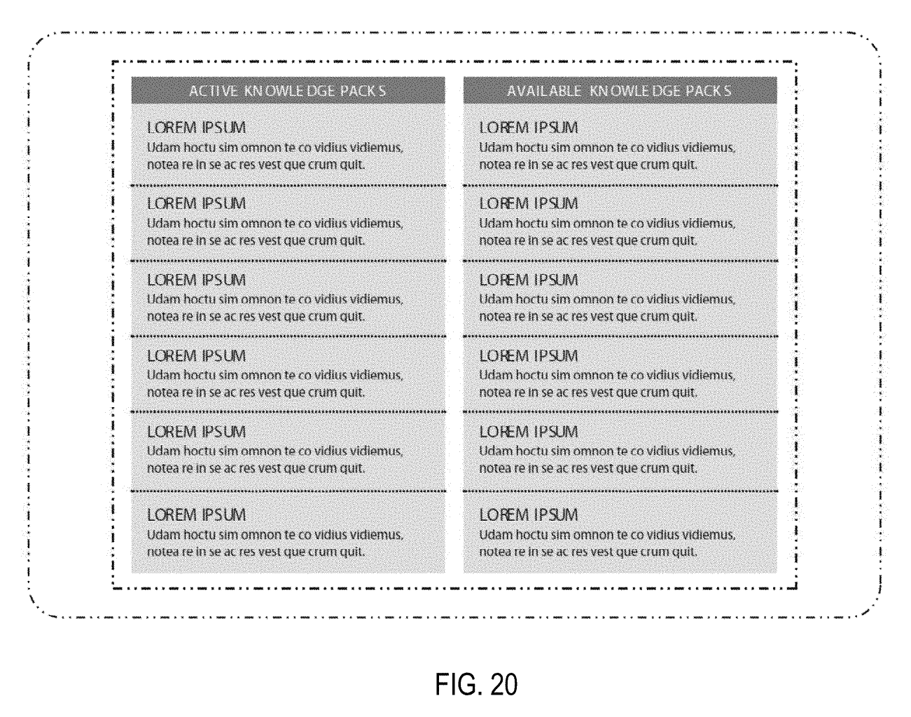

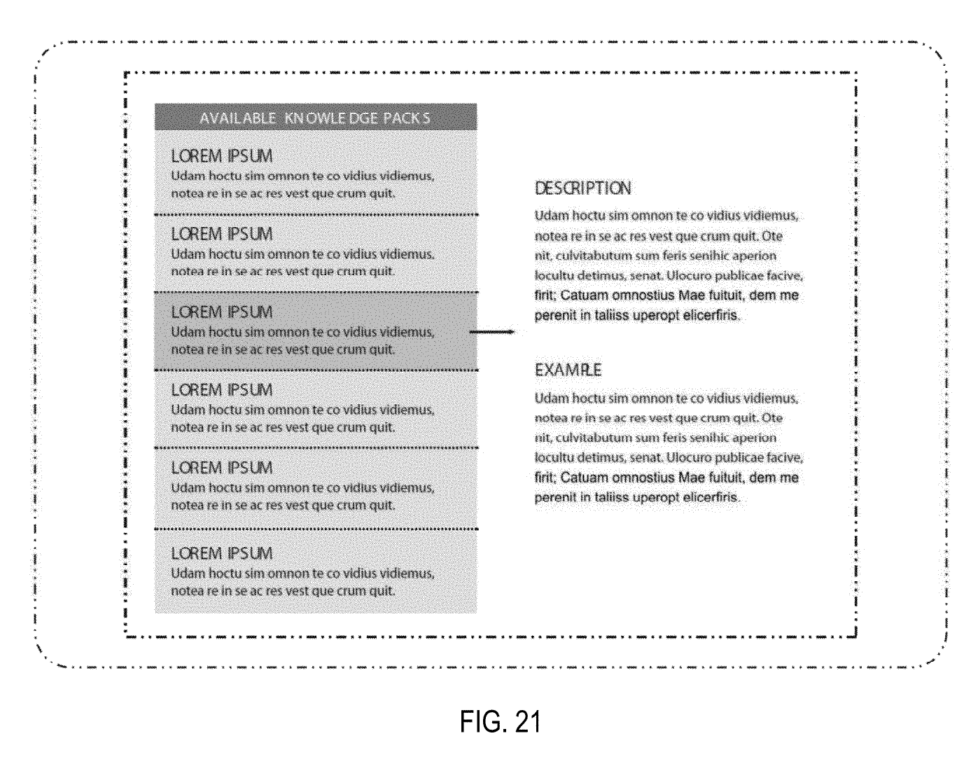

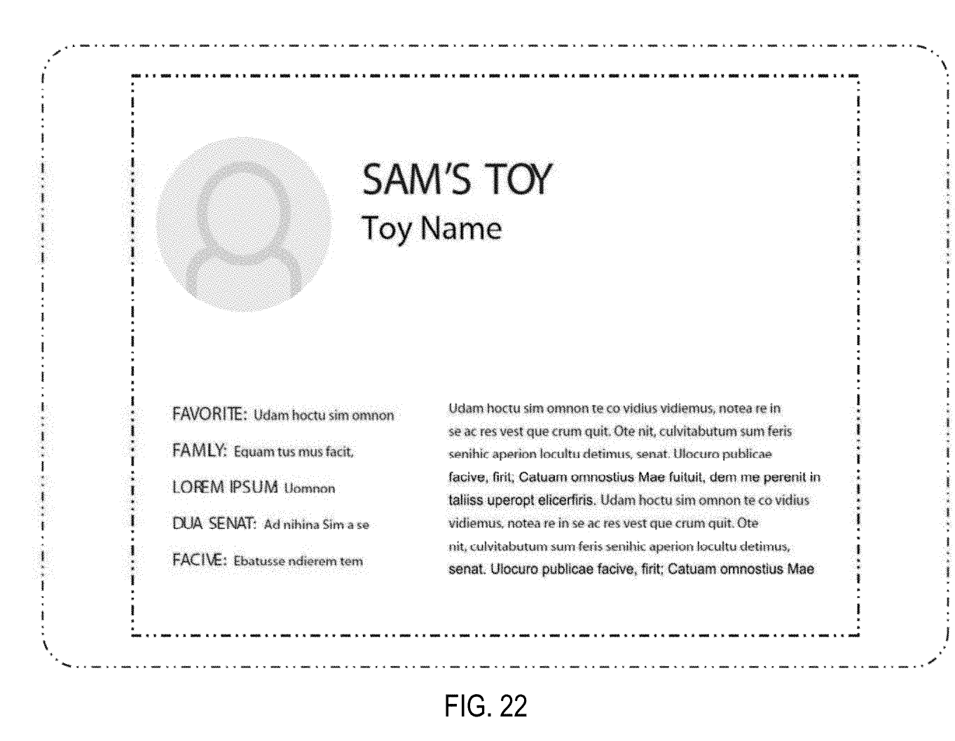

In the example screenshot shown in FIG. 18 a dashboard or home view is shown, making multiple metrics available, providing guardians an overview of system usage, and provides a drilled down report. In the example screenshot shown in FIG. 19 a keyword filtering panel is shown. This panel allows guardians to enter restricted keywords. It provides: color coding to indicate if a keyword is blocked or redirected to parent; provides a breakdown of restricted interaction displayed below key entry; a dialog of restricted entry; and restricted questions asked, by keyword. In the example screenshots shown in FIGS. 20 and 21 knowledge packs are shown. Additional knowledge and discussion packs can be activated and purchased. In the example screenshot shown in FIG. 22 a Child Profile is shown. This is a panel for direct parental manipulation and setting of dialog variables such as favorite food, color, toy as well as age, name and other personalization information.

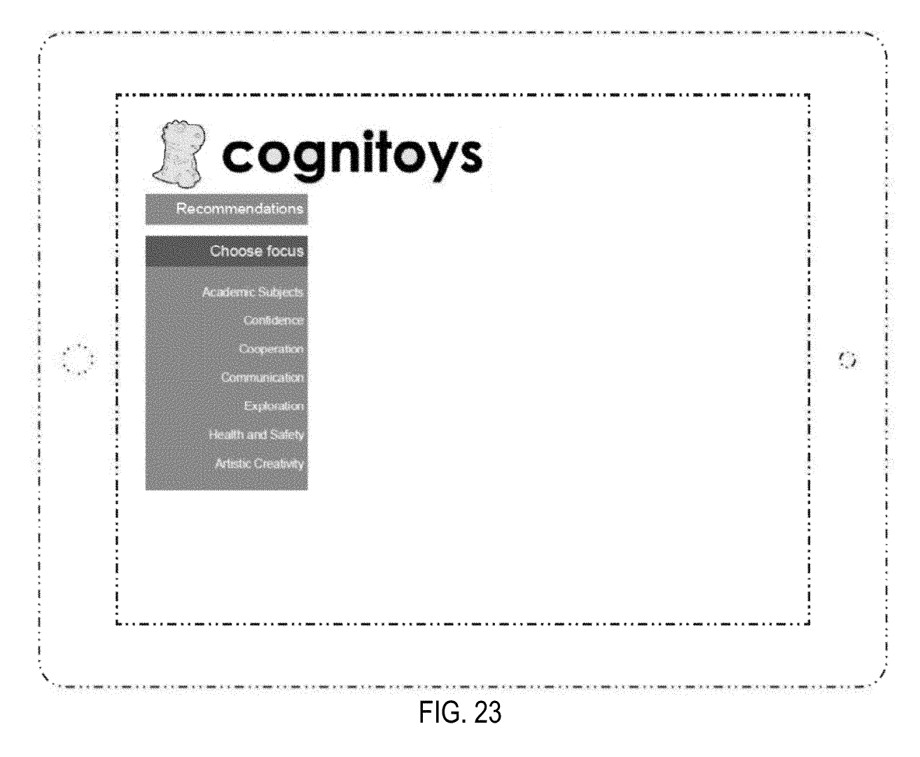

FIG. 23 is a screenshot of another view of the dashboard as described in FIG. 18. A menu allows the guardian to choose the content area or learning topic he or she wishes to browse.

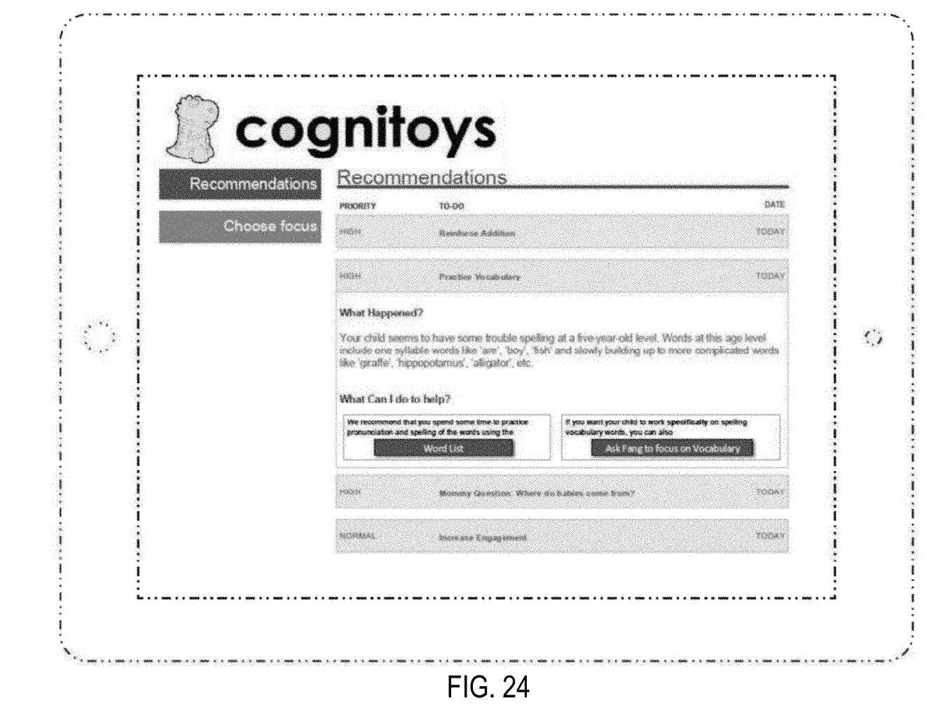

FIG. 24 is a screenshot of a content management interface that makes recommendations for content adjustment. This is a view that aggregates all items that need attention from different content areas, prioritized and dated. A content management interface and dashboard can be combined so the first thing the parent sees is the high priority items from the system.

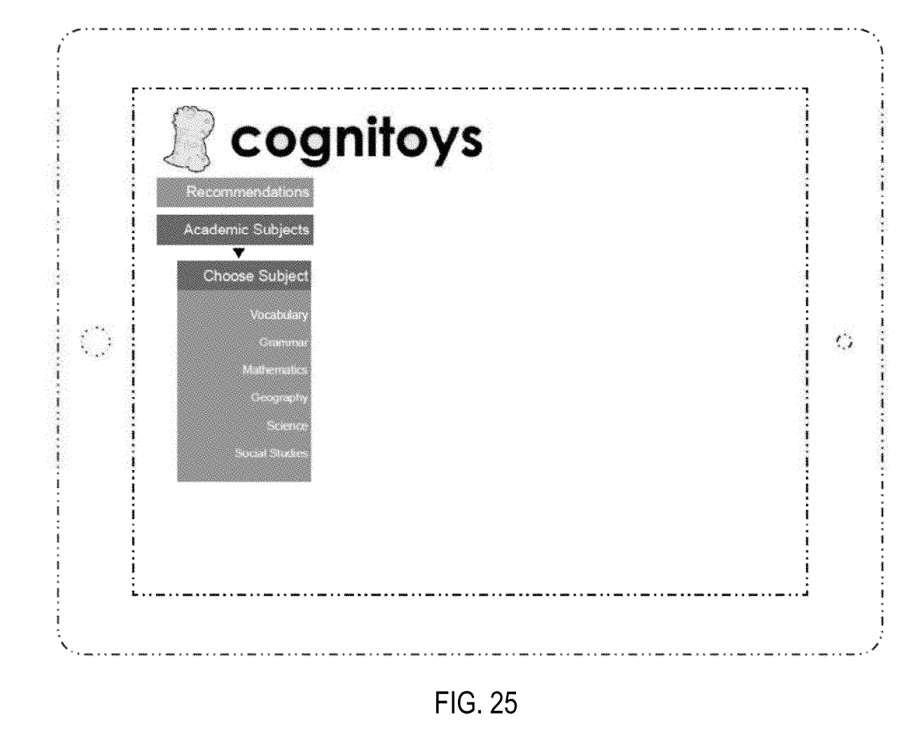

FIG. 25 is another screenshot of the content management interface that allows a guardian to select academic subjects, from a tree-structured menu in content organization.

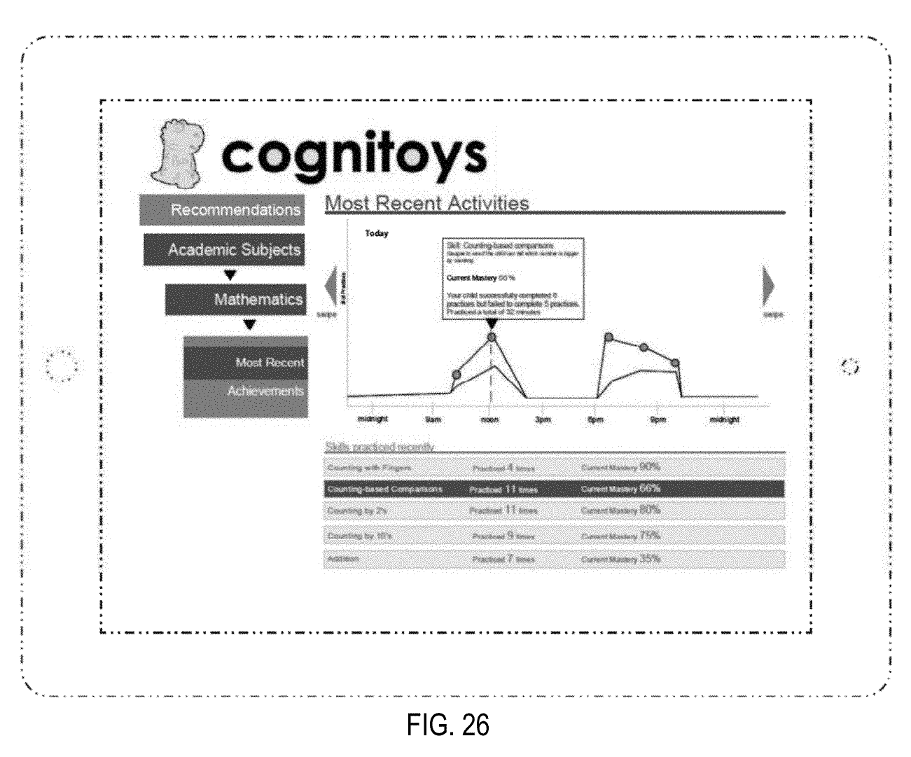

FIG. 26 is another screenshot of the content management interface that shows the device user's (the child's) activity, with frames for a particular content area (e.g. Mathematics). Metrics are displayed in graph form, such as a stacked line graph showing the number of successful trials vs. failed trials at a certain time during the day. A mouse-over tooltip also shows a description of the skill practiced and the child's current mastery of the skill in the form of a percentage.

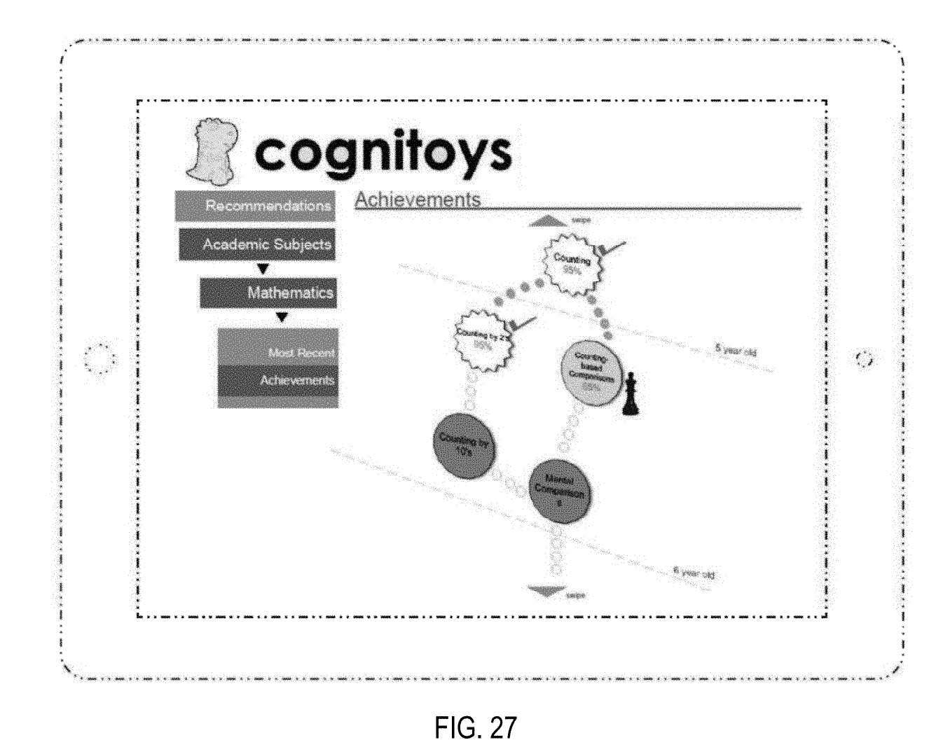

FIG. 27 is a screenshot of a usage-wide roadmap that shows what the child has learned and where the child should be heading next in the topics.

Through conversations, a stateful context-based interaction engagement device can maintain the child's basic profile (name, family, likes and dislikes, etc.) as well as the child's level of academic competence. Using the learned profile, the device can respond to the child's questions, or to actively ask questions to engage the child in entertainment or educational play.

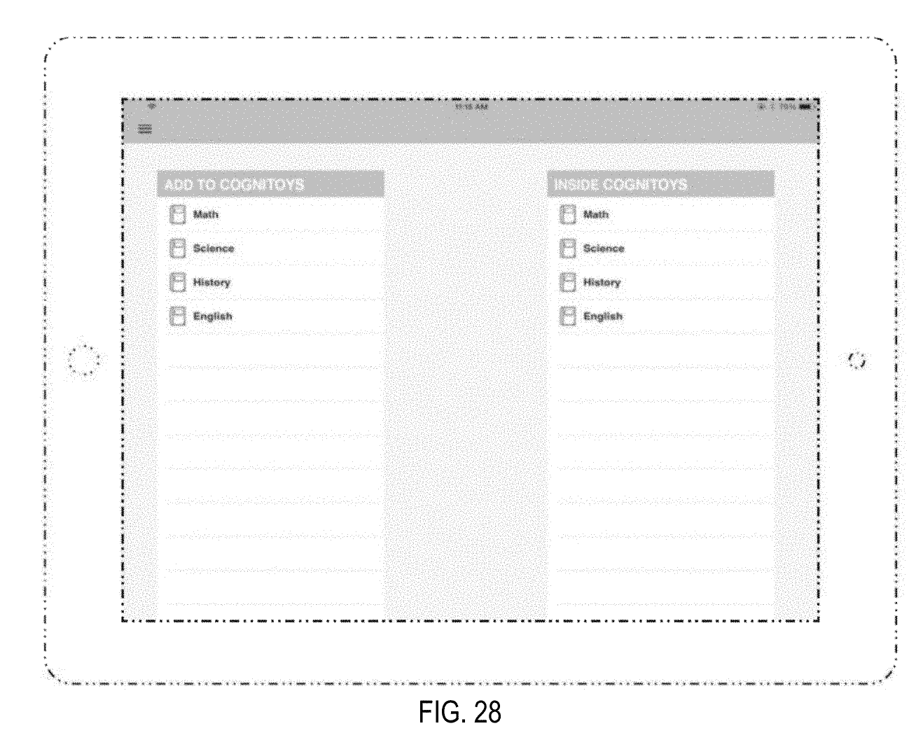

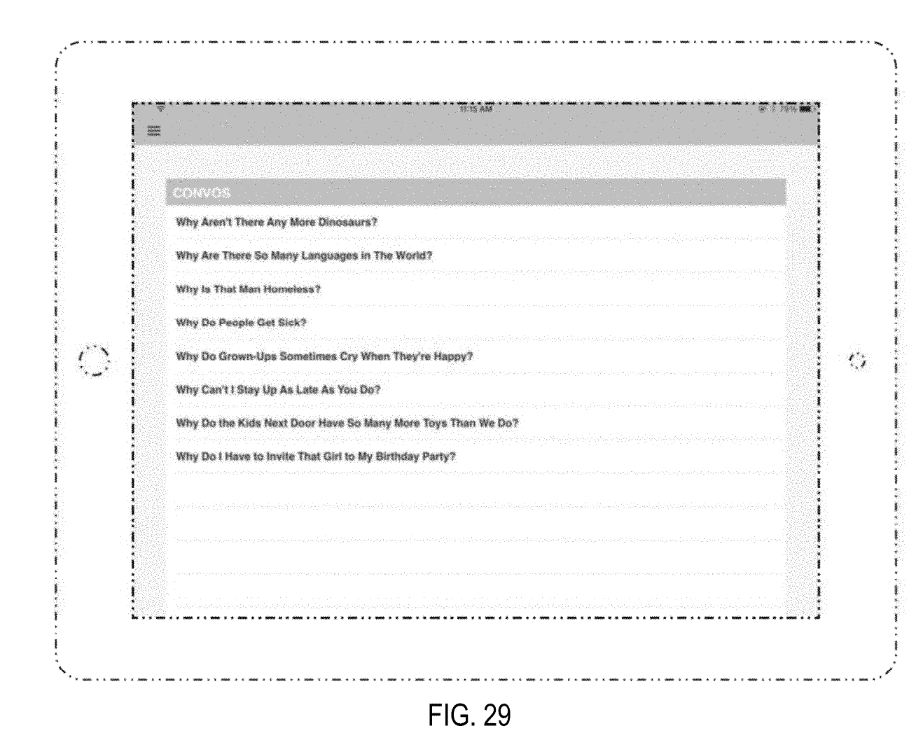

FIG. 28 shows a content management interface with content organized according to subject matter. FIG. 29 shows a content management interface with content organized according to conversation type.

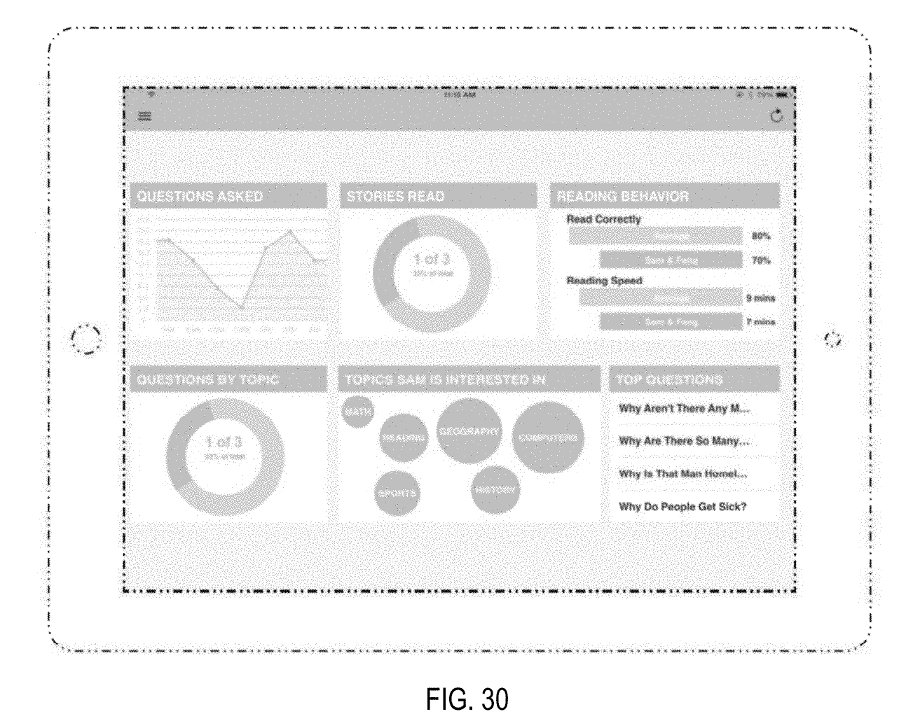

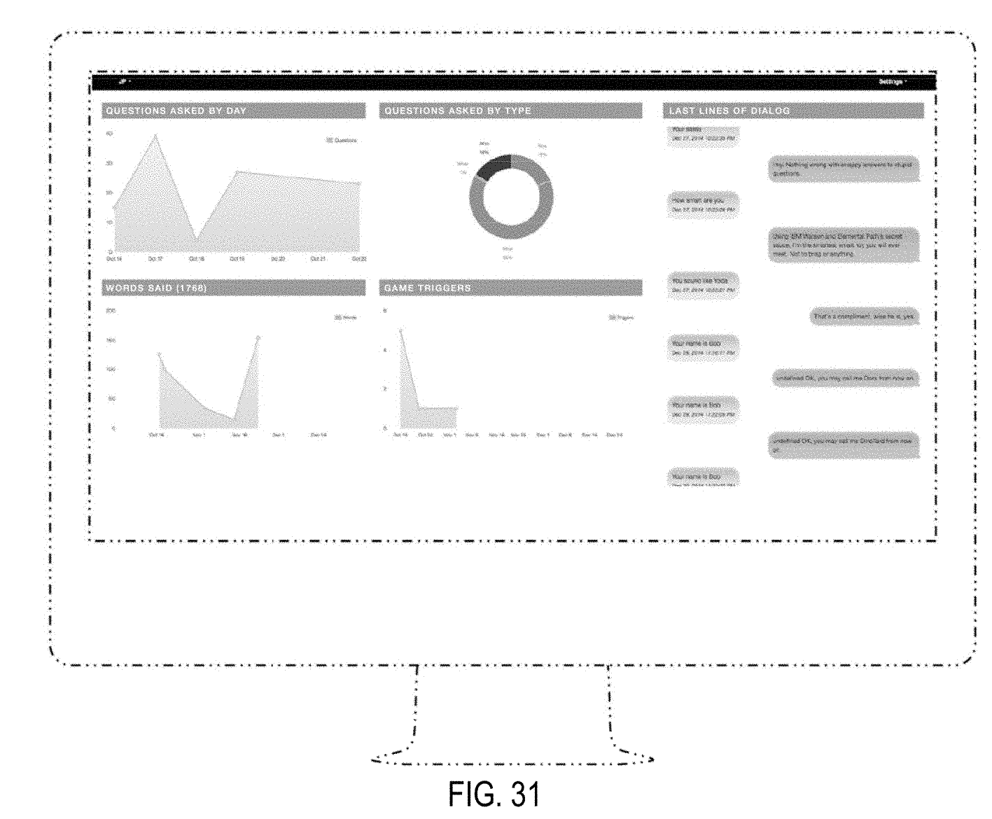

FIGS. 30 and 31 are additional screenshots of the Parent Panel interface. The metrics in this panel might include: the number of questions asked by the user per day; the percentage of questions by type (who, when, what, how); the number of words said by the user to date; the number of game triggers per day, such as ‘knock knock jokes’; the closing lines of the dialog.

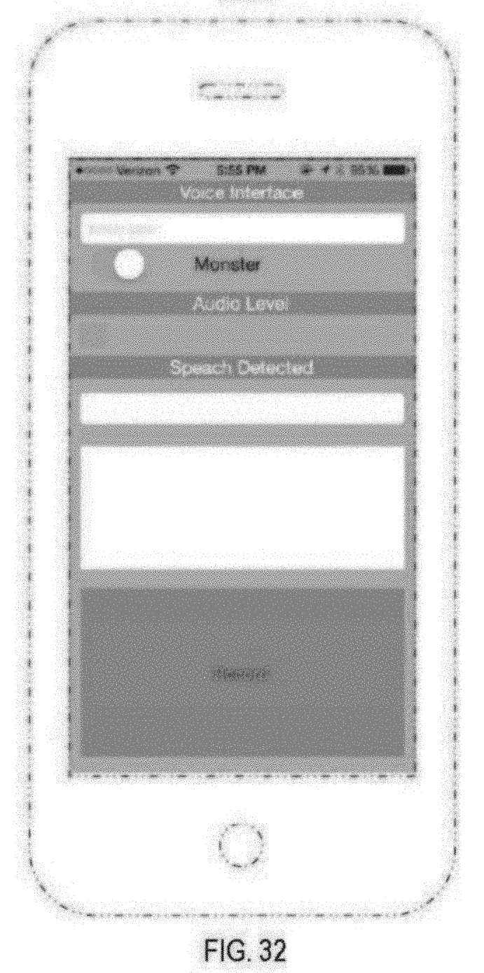

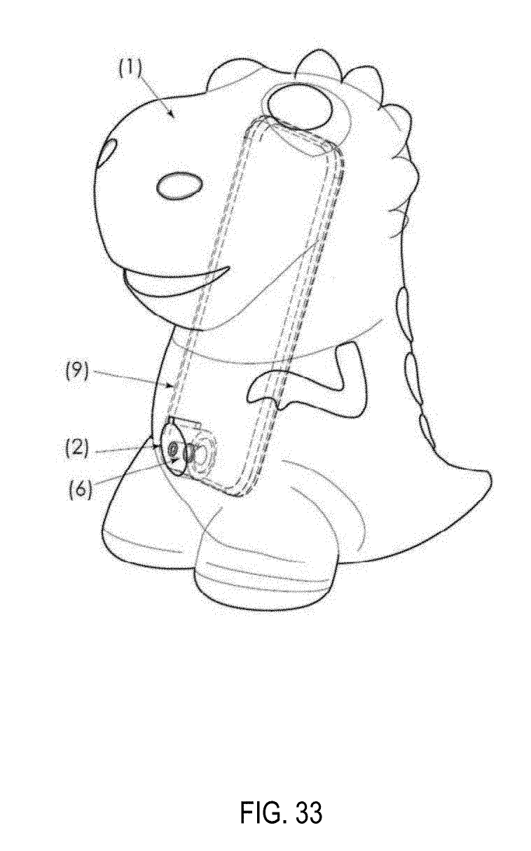

FIG. 32 is a front view of a removable stateful context-based interaction engagement device. FIG. 33 is a perspective view of a removable stateful context-based interaction engagement device integrated with a shell. The user operates the device in much the same way as the first embodiment. The user operates the device by pressing on an (2) actuating button, coated with a capacitive fabric, which activates a digital button on the multimedia device's (9) digitizer screen, to initiate an interaction with the database. A WiFi-enabled multimedia device, or smartphone (9) combines the functions of the microphone, speaker, PCB, pushbutton switch (6), and WiFi capability. The smartphone (9) is not considered part of this invention.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
receiving interaction input from a stateful context-based interaction engagement device based on user interactions of a user with the stateful context-based interaction engagement device;
defining a context associated with the user interactions based on the interaction input;
maintaining a state of communications between the user and the stateful context-based interaction engagement device based on the context associated with the user interactions;
selecting content to produce at the stateful context-based interaction engagement device based on the defined context associated with the user interactions and the maintained state of communications between the user and the stateful context-based interaction engagement device;
causing the stateful context-based interaction engagement device to produce the content in response to the user interaction of the user with the stateful context-based interaction engagement device.

2. The method of claim 1, wherein the interaction input includes an audio stream of a recording of utterances made by the user as part of the user interactions of the user with the stateful context-based interaction engagement device, the method further comprising:
determining a semantic construct of the utterances made by the user using the audio stream of a recording of utterances made by the user as part of the interaction input;
defining the context associated with the user interactions based on the determined semantic construct of the utterances made by the user.

3. The method of claim 1, further comprising:
recommending the content to another user associated with the stateful context-based interaction engagement device based on characteristics of the user;
receiving input from the another user indicating to potentially produce the content for the user through the stateful context-based interaction engagement device;
selecting the content to produce at the stateful context-based interaction engagement device based, at least in part, on the input received from the another user indicating to potentially produce the content for the user through the stateful context-based interaction engagement device.

4. The method of claim 1, wherein the interaction input includes an audio stream of a recording of utterances made by the user as part of the user interactions of the user with the stateful context-based interaction engagement device, the method further comprising:
determining a semantic construct of the utterances made by the user by applying either or both natural language processing and structured machine language processing to the audio stream of a recording of utterance made by the user as part of the interaction input;
defining the context associated with the user interactions based on the determined semantic construct of the utterances made by the user.

5. The method of claim 1, wherein the state of communications includes a dialog tree indicating dialog between the user and the stateful context-based interaction engagement device.

6. The method of claim 1, wherein the state of communications includes contexts of past instances of communications between the stateful context-based interaction engagement device and the user.

7. The method of claim 1, further comprising:
gathering the interaction input at the stateful context-based interaction engagement device;
modifying the interaction input to create modified interaction input at the stateful context-based interaction engagement device by sampling and encrypting the interaction input;
providing the modified interaction input as the interaction input from the stateful context based interaction engagement device in a stream.

8. The method of claim 1, wherein the interaction input is received, at least in part, from the stateful context-based interaction engagement device through a wireless connection.

9. The method of claim 1, further comprising:
determining metrics related to communications of the user and the stateful context-based interaction engagement device based on the determined state of communications between the user and the stateful context-based interaction engagement device;
defining a skill level of the user based on the determined metrics related to communications of the user and the stateful context-based interaction engagement device;
further selecting the content to produce at the stateful context-based interaction engagement device based on the defined skill level of the user.

10. The method of claim 1, further comprising:
defining stateful context-based content production rules for the content;
selecting the content according to the stateful context-based content production rules based on the defined context associated with the user interactions and the maintained state of communications between the user and the stateful context-based interaction engagement device.

11. A system comprising:
an interaction input communication engine configured to receive interaction input from a stateful context-based interaction engagement device based on user interactions of a user with the stateful context-based interaction engagement device;
an interaction-based context determination engine configured to define a context associated with the user interactions based on the interaction input;
a state maintenance engine configured to maintain a state of communications between the user and the stateful context-based interaction engagement device based on the context associated with the user interactions;
a state and context-based content production engine configured to:
select content to produce at the stateful context-based interaction engagement device based on the defined context associated with the user interactions and the maintained state of communications between the user and the stateful context-based interaction engagement device;
cause the stateful context-based interaction engagement device to produce the content in response to the user interaction of the user with the stateful context-based interaction engagement device.

12. The system of claim 11, wherein the interaction input includes an audio stream of a recording of utterances made by the user as part of the user interactions of the user with the stateful context-based interaction engagement device, the interaction based-context determination engine further configured to:
determine a semantic construct of the utterances made by the user using the audio stream of a recording of utterances made by the user as part of the interaction input;
define the context associated with the user interactions based on the determined semantic construct of the utterances made by the user.

13. The system of claim 11, further comprising:
a content management engine configured to:
recommend the content to another user associated with the stateful context-based interaction engagement device based on characteristics of the user;
receive input from the another user indicating to potentially produce the content for the user through the stateful context-based interaction engagement device;
the state and context-based content production engine further configured to:
select the content to produce at the stateful context-based interaction engagement device based, at least in part, on the input received from the another user indicating to potentially produce the content for the user through the stateful context-based interaction engagement device.

14. The system of claim 11, wherein the interaction input includes an audio stream of a recording of utterances made by the user as part of the user interactions of the user with the stateful context-based interaction engagement device, the interaction-based context determination engine further configured to:
determine a semantic construct of the utterances made by the user by applying either or both natural language processing and structured machine language processing to the audio stream of a recording of utterance made by the user as part of the interaction input;
define the context associated with the user interactions based on the determined semantic construct of the utterances made by the user.

15. The system of claim 11, wherein the state of communications includes a dialog tree indicating dialog between the user and the stateful context-based interaction engagement device.

16. The system of claim 11, wherein the state of communications includes contexts of past instances of communications between the stateful context-based interaction engagement device and the user.

17. The system of claim 11, further comprising:
an interaction input gathering engine configured to gather the interaction input at the stateful context-based interaction engagement device;
an interaction input modification engine configured to modify the interaction input to create modified interaction input at the stateful context-based interaction engagement device by sampling and encrypting the interaction input;
a stateful context-based interaction engagement device communication engine configured to provide the modified interaction input as the interaction input from the stateful context based interaction engagement device in a stream.

18. The system of claim 11, wherein the interaction input is received, at least in part, from the stateful context-based interaction engagement device through a wireless connection.

19. The system of claim 11, further comprising:
a metric determination engine configured to determine metrics related to communications of the user and the stateful context-based interaction engagement device based on the determined state of communications between the user and the stateful context-based interaction engagement device;
a user profile management engine configured to define a skill level of the user based on the determined metrics related to communications of the user and the stateful context-based interaction engagement device;
the state and context-based content production engine further configured to select the content to produce at the stateful context-based interaction engagement device based on the defined skill level of the user.

20. A system comprising:
means for receiving interaction input from a stateful context-based interaction engagement device based on user interactions of a user with the stateful context-based interaction engagement device;
means for defining a context associated with the user interactions based on the interaction input;
means for maintaining a state of communications between the user and the stateful context-based interaction engagement device based on the context associated with the user interactions;
means for selecting content to produce at the stateful context-based interaction engagement device based on the defined context associated with the user interactions and the maintained state of communications between the user and the stateful context-based interaction engagement device;
means for causing the stateful context-based interaction engagement device to produce the content in response to the user interaction of the user with the stateful context-based interaction engagement device.
